(19) United States
(12) Patent Application Publication
(10) Pub. No.: US 2024/0357519 A1
(43) Pub. Date: Oct. 24, 2024

(54) TRANSMITTING A MAC CE MESSAGE BY AN IAB NODE

(71) Applicant: Lenovo (Singapore) Pte. Ltd., New Tech Park (SG)

(72) Inventors: Majid Ghanbarinejad, Chicago, IL (US); Vijay Nangia, Woodridge, IL (US); Hyejung Jung, Northbrook, IL (US)

(21) Appl. No.: 18/681,273

(22) PCT Filed: Aug. 4, 2022
(86) PCT No.: PCT/IB2022/057272

§ 371 Date: Feb. 5, 2024

Related U.S. Application Data
(60) Provisional application No. 63/229,908, filed on Aug. 5, 2021.

(51) Int. Cl. H04W 52/46; H04W 52/36

(52) U.S. Cl. CPC H04W 52/46; H04W 52/36

(57) ABSTRACT

Apparatuses, methods, and systems are disclosed for transmitting a MAC CE message by an IAB node. One method includes transmitting, at a first IAB node, a MAC CE message to a second IAB node. The MAC CE message includes: an ID associated with a resource configuration; a transmission power offset value; a maximum transmission power value; information corresponding to a multiplexing mode; at least one uplink beam identifier; a first indication of association with a MT of the first IAB node; a second indication of association with a cell of a DU of the first IAB node; or some combination thereof.

### CROSS-REFERENCE TO RELATED APPLICATIONS

This application claims priority to U.S. Patent Application Ser. No. 63/229,908 entitled “APPARATUSES, METHODS, AND SYSTEMS FOR POWER HEADROOM SIGNALING IN INTEGRATED ACCESS AND BACKHAUL” and filed on Aug. 5, 2021 for Majid Ghanbarinejad et al., which is incorporated herein by reference in its entirety.

### FIELD

The subject matter disclosed herein relates generally to wireless communications and more particularly relates to transmitting a MAC CE message by an IAB node.

### BACKGROUND

In certain wireless communications networks, information corresponding to an IAB system may be unknown. In such networks, the information may need to be provided to devices.

### BRIEF SUMMARY

Methods for transmitting a MAC CE message by an IAB node are disclosed. Apparatuses and systems also perform the functions of the methods. One embodiment of a method includes transmitting, at a first IAB node, a MAC CE message to a second IAB node. The MAC CE message includes: an ID associated with a resource configuration: a transmission power offset value: a maximum transmission power value: information corresponding to a multiplexing mode: at least one uplink beam identifier: a first indication of association with a MT of the first IAB node: a second indication of association with a cell of a DU of the first IAB node: or some combination thereof.

One apparatus for transmitting a MAC CE message by an IAB node includes a transmitter to transmit a MAC CE message to a second IAB node. The MAC CE message includes: an ID associated with a resource configuration: a transmission power offset value: a maximum transmission power value: information corresponding to a multiplexing mode: at least one uplink beam identifier; a first indication of association with a MT of the first IAB node: a second indication of association with a cell of DU of the first IAB node: or some combination thereof.

Another embodiment of a method for transmitting a MAC CE message by an IAB node includes transmitting, at a first IAB node, a MAC CE message to a second IAB node. The MAC CE message includes: an ID associated with a resource configuration: a transmission power offset value: a maximum transmission power value: information corresponding to a multiplexing mode: at least one uplink beam identifier: a first indication of association with a MT of the first IAB node: a second indication of association with a cell of a DU of the first IAB node: or some combination thereof. The second IAB node is a parent node of the first IAB node. The MAC CE message indicates a range of transmission power for an uplink from the first IAB node to the second IAB node. The range is indicated by a combination of the maximum transmission power value and the transmission power offset value. The multiplexing mode includes: the MT transmitting and the DU transmitting: the MT receiving and the DU receiving: the MT transmitting and the DU receiving: the MT receiving and the MT transmitting: or some combination thereof. The MAC CE message indicates that the parent node applies the range in response to: the first IAB node using a resource associated with the resource configuration: the first IAB node applying the indicated multiplexing mode: the first IAB node applying a beam indicated by the at least one uplink beam identifier: or some combination thereof.

Another apparatus for transmitting a MAC CE message by an IAB node includes a transmitter to transmit a MAC CE message to a second IAB node. The MAC CE message includes: an ID associated with a resource configuration: a transmission power offset value: a maximum transmission power value: information corresponding to a multiplexing mode: at least one uplink beam identifier: a first indication of association with a MT of the first IAB node: a second indication of association with a cell of a DU of the first IAB node: or some combination thereof. The second IAB node is a parent node of the first IAB node. The MAC CE message indicates a range of transmission power for an uplink from the first IAB node to the second IAB node. The range is indicated by a combination of the maximum transmission power value and the transmission power offset value. The multiplexing mode includes: the MT transmitting and the DU transmitting: the MT receiving and the DU receiving: the MT transmitting and the DU receiving: the MT receiving and the MT transmitting: or some combination thereof. The MAC CE message indicates that the parent node applies the range in response to: the first IAB node using a resource associated with the resource configuration: the first IAB node applying the indicated multiplexing mode: the first IAB node applying a beam indicated by the at least one uplink beam identifier: or some combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for transmitting a MAC CE message by an IAB node;

FIG. 2 is a schematic block diagram illustrating one embodiment of an apparatus that may be used for transmitting a MAC CE message by an IAB node:

FIG. 3 is a schematic block diagram illustrating one embodiment of an apparatus that may be used for transmitting a MAC CE message by an IAB node:

FIG. 4 is a schematic block diagram illustrating one embodiment of an IAB system in standalone mode:

FIG. 5 is a schematic block diagram illustrating another embodiment of a system:

FIG. 6 is a schematic block diagram illustrating one embodiment of an IAB system with single-panel and multi-panel IAB nodes:

FIG. 7 is a schematic block diagram illustrating one embodiment of types of simultaneous transmission and/or reception operations:

FIG. 8 is a block diagram illustrating one embodiment of a single entry PHR MAC CE:

FIG. 9 is a block diagram illustrating one embodiment of a multiple entry PHR MAC CE with the highest ServCellIndex of serving cell with configured uplink is less than 8:

FIG. 10 is a block diagram illustrating another embodiment of a multiple entry PHR MAC CE with the highest ServCellIndex of serving cell with configured uplink is equal to or higher than 8:

FIG. 11 is a code diagram illustrating one embodiment of a PHR-Config IE:

FIG. 12 is a block diagram illustrating one embodiment of a system including a subject IAB node (N) performing transmissions to a parent node or IAB donor (PN) in the IAB node's upstream and a child node or UE in the IAB node's downstream:

FIG. 13 is a code diagram illustrating one embodiment of an RRC configuration IE:

FIG. 14 is a schematic block diagram illustrating one embodiment of a DC architecture with one IAB-CU and/or IAB donor (intra-donor scenario):

FIG. 15 is a schematic block diagram illustrating one embodiment of a DC architecture with multiple IAB-CUs and/or IAB donors (intra-donor scenario):

FIG. 16 is a schematic block diagram illustrating one embodiment of a system showing alternative scenarios for simultaneous operations:

FIG. 17 is a flow chart diagram illustrating one embodiment of a method for transmitting a MAC CE message by an IAB node; and

FIG. 18 is a flow chart diagram illustrating another embodiment of a method for transmitting a MAC CE message by an IAB node.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an crasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

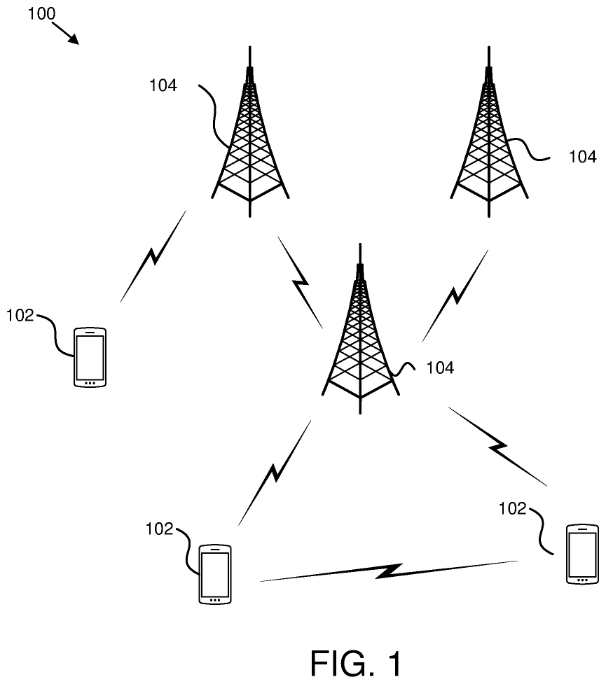

FIG. 1 depicts an embodiment of a wireless communication system 100 for transmitting a MAC CE message by an IAB node. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“cNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth R, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 and/or a network unit 104 may transmit, a MAC CE message to a second IAB node. The MAC CE message includes: an ID associated with a resource configuration: a transmission power offset value: a maximum transmission power value: information corresponding to a multiplexing mode: at least one uplink beam identifier; a first indication of association with a MT of the first IAB node: a second indication of association with a cell of a DU of the first IAB node: or some combination thereof. Accordingly, the remote unit 102 and/or the network unit 104 may be used for transmitting a MAC CE message by an IAB node.

In certain embodiments, a remote unit 102 and/or a network unit 104 may transmit, at a first IAB node, a MAC CE message to a second IAB node. The MAC CE message includes: an ID associated with a resource configuration: a transmission power offset value: a maximum transmission power value: information corresponding to a multiplexing mode: at least one uplink beam identifier: a first indication of association with a MT of the first IAB node: a second indication of association with a cell of a DU of the first IAB node: or some combination thereof. The second IAB node is a parent node of the first IAB node. The MAC CE message indicates a range of transmission power for an uplink from the first IAB node to the second IAB node. The range is indicated by a combination of the maximum transmission power value and the transmission power offset value. The multiplexing mode includes: the MT transmitting and the DU transmitting: the MT receiving and the DU receiving: the MT transmitting and the DU receiving: the MT receiving and the MT transmitting: or some combination thereof. The MAC CE message indicates that the parent node applies the range in response to: the first IAB node using a resource associated with the resource configuration: the first IAB node applying the indicated multiplexing mode: the first IAB node applying a beam indicated by the at least one uplink beam identifier: or some combination thereof. Accordingly, the remote unit 102 and/or the network unit 104 may be used for transmitting a MAC CE message by an IAB node.

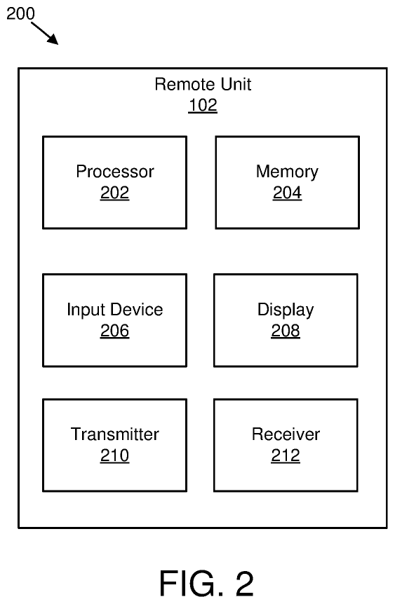

FIG. 2 depicts one embodiment of an apparatus 200 that may be used for transmitting a MAC CE message by an IAB node. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the transmitter 210 to transmit a MAC CE message to a second IAB node. The MAC CE message includes: an ID associated with a resource configuration: a transmission power offset value: a maximum transmission power value: information corresponding to a multiplexing mode: at least one uplink beam identifier: a first indication of association with a MT of the first IAB node: a second indication of association with a cell of DU of the first IAB node: or some combination thereof.

In some embodiments, the transmitter 210 to transmit a MAC CE message to a second IAB node. The MAC CE message includes: an ID associated with a resource configuration: a transmission power offset value: a maximum transmission power value: information corresponding to a multiplexing mode: at least one uplink beam identifier: a first indication of association with a MT of the first IAB node: a second indication of association with a cell of a DU of the first IAB node: or some combination thereof. The second IAB node is a parent node of the first IAB node. The MAC CE message indicates a range of transmission power for an uplink from the first IAB node to the second IAB node. The range is indicated by a combination of the maximum transmission power value and the transmission power offset value. The multiplexing mode includes: the MT transmitting and the DU transmitting: the MT receiving and the DU receiving: the MT transmitting and the DU receiving: the MT receiving and the MT transmitting: or some combination thereof. The MAC CE message indicates that the parent node applies the range in response to: the first IAB node using a resource associated with the resource configuration: the first IAB node applying the indicated multiplexing mode: the first IAB node applying a beam indicated by the at least one uplink beam identifier: or some combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

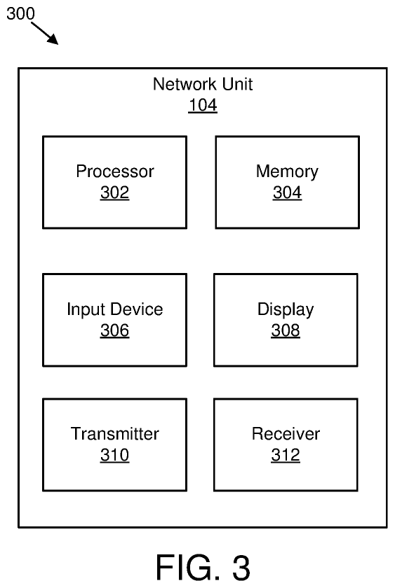

FIG. 3 depicts one embodiment of an apparatus 300 that may be used for transmitting a MAC CE message by an IAB node. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 to transmit a MAC CE message to a second IAB node. The MAC CE message includes: an ID associated with a resource configuration: a transmission power offset value: a maximum transmission power value: information corresponding to a multiplexing mode: at least one uplink beam identifier: a first indication of association with a MT of the first IAB node: a second indication of association with a cell of DU of the first IAB node: or some combination thereof.

In some embodiments, the transmitter 310 to transmit a MAC CE message to a second IAB node. The MAC CE message includes: an ID associated with a resource configuration: a transmission power offset value: a maximum transmission power value: information corresponding to a multiplexing mode: at least one uplink beam identifier: a first indication of association with a MT of the first IAB node: a second indication of association with a cell of a DU of the first IAB node: or some combination thereof. The second IAB node is a parent node of the first IAB node. The MAC CE message indicates a range of transmission power for an uplink from the first IAB node to the second IAB node. The range is indicated by a combination of the maximum transmission power value and the transmission power offset value. The multiplexing mode includes: the MT transmitting and the DU transmitting: the MT receiving and the DU receiving: the MT transmitting and the DU receiving: the MT receiving and the MT transmitting: or some combination thereof. The MAC CE message indicates that the parent node applies the range in response to: the first IAB node using a resource associated with the resource configuration: the first IAB node applying the indicated multiplexing mode: the first IAB node applying a beam indicated by the at least one uplink beam identifier: or some combination thereof.

It should be noted that one or more embodiments described herein may be combined into a single embodiment.

In certain embodiments, integrated access and backhaul (“IAB”) may be used for new radio (“NR”) access technology. The IAB technology aims at increasing deployment flexibility and reducing fifth generation (“5G”) rollout costs. Moreover, IAB allows service providers to reduce cell planning and spectrum planning efforts while using the wireless backhaul technology.

In some embodiments, although IAB is not limited to a specific multiplexing and duplexing scheme, it may focus is on time-division multiplexing (“TDM”) between upstream communications (e.g., with a parent IAB node or IAB donor) and downstream communications (e.g., with a child IAB node or a UE).

In various embodiments, IAB system enhance resource multiplexing for supporting simultaneous operations (e.g., transmissions and/or receptions) in downstream and upstream by an IAB node includes duplexing enhancements, such as: 1) specification of enhancements to the resource multiplexing between child and parent links of an IAB node, including, a) support of simultaneous operation (e.g., transmission and/or reception) of IAB-node's child and parent links (e.g., mobile terminal (“MT”) MT transmit (“TX”) and distributed unit (“DU”) TX, MT TX and DU receive (“RX”), MT RX and DU TX, MT RX and DU RX), and b) support for dual-connectivity scenarios defined in the context of topology redundancy for improved robustness and load balancing; and/or 2) specification of IAB-node timing modes, extensions for downlink (“DL”) and/or UL power control, and command line interface (“CLI”) and interference measurements of backhaul (“BH”) links, as needed, to support simultaneous operation (e.g., transmission and/or reception) by IAB-node's child and parent links.

In certain embodiments, enhancements to power control in uplink and/or downlink may be used to assist the IAB system with fulfilling a larger number of transmission power constraints such as power imbalance and total power constraints.

In some embodiments, a power imbalance constraint may be imposed by a difference of transmission powers of signals transmitted by one or more (e.g., collocated) antenna panels, or a difference of reception powers of signals received by one or more (e.g., collocated) antenna panels. The power imbalance may be imposed by the hardware and may additionally impact beamforming on any or all antenna panels.

In various embodiments, a total power constraint may be imposed by hardware, emission power regulations such as federal communications commission (“FCC”) regulations, or a combination thereof.

In some embodiments, there may be a condition in which an IAB node may transmit signals to a parent node and/or donor and a child node and/or user equipment (“UE”) simultaneously. In such embodiments, the IAB node may have two constraints on the maximum transmission power to the parent node: 1) one determined by a power headroom (“PH”) associated with a total transmission power by the IAB node; and 2) the other by a maximum power imbalance between simultaneous transmissions to the parent node and/or donor and child node and/or UE.

In various embodiments, it may be determined how to convey information to a parent node and/or donor that performs uplink power control (“UL-PC”) on the IAB-MT of the IAB node.

In certain embodiments, power headroom reporting (“PHR”) may dynamically inform a parent node and/or donor of the variations caused by transmissions to the child node and/or UE. However, in such embodiments: 1) there may be a change of power constraints due to transmission to the child node and/or UE that may be excessively dynamic and changing rapidly (e.g., from slot to slot) because not all slots are used for simultaneous transmissions; and 2) the IAB node may transmit to multiple child nodes and/or UEs, and there may be enhancements for enabling some downlink power control (“DL-PC”) mechanisms to different child nodes and/or UEs to add further variations to the uplink transmission power constraints.

In some embodiments, it may be determined whether legacy UL power control mechanism (e.g., including PHR) is sufficient for an IAB-node operating in an enhanced multiplexing mode. The IAB-node indicating information to assist with its UL power control may be supported. In various embodiments, it may be determined whether to support an IAB-node indicating assistance information to help with its MT's UL TX power control. The assistance information may be: 1) a desired TX power: 2) an offset to a baseline PHR: 3) a desired dynamic range: 4) whether the assistance information is provided to the parent-node, the CU, or both; and/or 5) whether the MT's UL TX power control formula needs to be changed.

In certain embodiments, there may be methods and systems corresponding to PHR signaling.

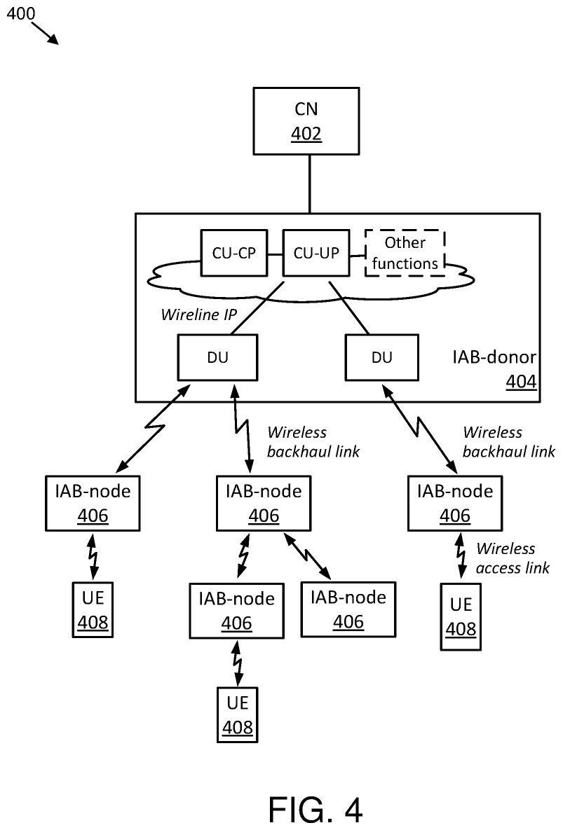

FIG. 4 is a schematic block diagram illustrating one embodiment of an IAB system 400 in standalone mode. The IAB system 400 includes a core network (“CN”) 402, an IAB-donor 404, IAB-nodes 406, and UEs 408. The CN 402 is connected to the IAB donor 404 of the IAB system 400 through a backhaul link, which is typically wired. The IAB donor 404 includes a central unit (“CU”) that communicates with all the distributed units (“DUs”) in the system through an F1 interface. The IAB donor 404 is a single logical node that may include a set of functions such as gNB-DU, gNB-CU-CP, gNB-CU-UP, and so forth. In certain deployments, the IAB donor 404 may be split according to these functions, which may all be either collocated or non-collocated. Moreover, each IAB node may be functionally split into at least a DU and a mobile terminal (“MT”). An MT of an IAB node may be connected to a DU of a parent node, which may be another IAB node or an IAB donor. A Uu link between an MT of an IAB node (called an IAB-MT) and a DU of a parent node (called an IAB-DU) is called a wireless backhaul link. In a wireless backhaul link, in terms of functionalities, the MT is similar to a UE and the DU of the parent node is similar to a base station in a conventional cellular wireless access link. Therefore, a link from an MT to a serving cell that is a DU of a parent link is called an uplink, and a link in the reverse direction is called a downlink. As used herein, embodiments may refer to an uplink or a downlink between IAB nodes, an upstream link or a downstream link of an IAB node, a link between a node and its parent node, a link between a node and its child node, and so forth without a direct reference to an IAB-MT, IAB-DU, serving cell, and so forth.

Each IAB donor or IAB node may serve UEs through access links. IAB systems may be designed to enable multi-hop communications (e.g., a UE may be connected to a core network through an access link and multiple backhaul links between IAB nodes and an IAB donor). As used herein, unless stated otherwise, an IAB node may refer to an IAB node or an IAB donor.

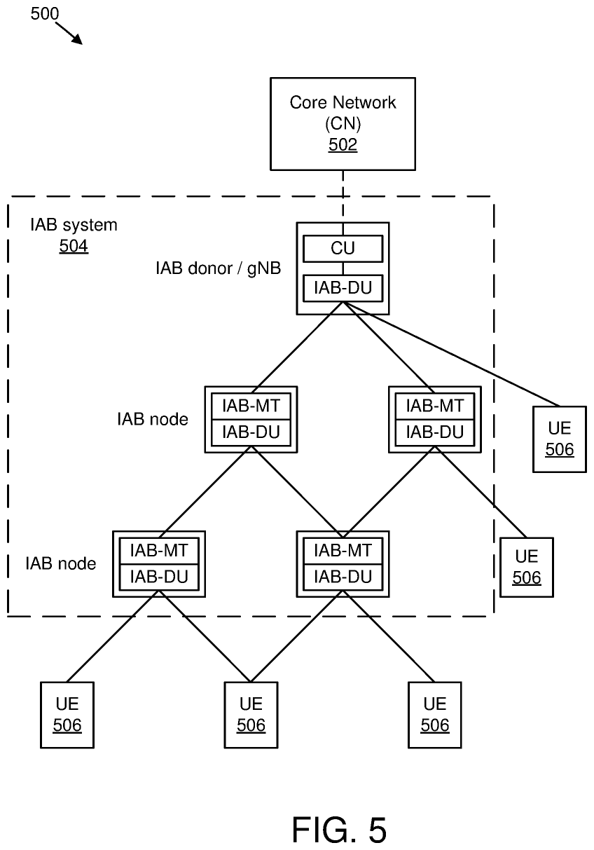

FIG. 5 is a schematic block diagram illustrating another embodiment of a system 500. Specifically, FIG. 5 illustrates functional splits of an IAB donor and IAB nodes. In this figure, an IAB node or a UE can be served by more than one serving cell as they support dual connectivity (“DC”). The system 500 includes a CN 502, an IAB system 504, and UEs 506. The CU and/or DU (“CU/DU”) split is in an IAB donor in the IAB system 504, and the DU/MT split is in IAB nodes in the IAB system 504.

It should be noted that a node and/or link closer to the IAB donor and/or CN 502 is called an upstream node and/or link. For example, a parent node of a subject node is an upstream node of the subject node and the link to the parent node is an upstream link with respect to the subject node. Similarly, a node and/or link farther from the IAB donor and/or core network is called a downstream node and/or link. For example, a child node of a subject node is a downstream node of the subject node and the link to the child node is a downstream link with respect to the subject node.

Table 1 summarize the terminology used herein for the sake of brevity versus a description that may appear in a specification.

TABLE 1

| Phrase | Description |
|---|---|
| Wireless | A connection between an MT of an IAB node |
| backhaul link | and a DU of a serving cell |
| Wireless access | A connection between a UE and (a DU of) a |
| link | serving cell |
| IAB-node/IAB | RAN node that supports NR access links to |
| node | UEs and NR backhaul links to parent nodes |
| | and child nodes |
| IAB-MT | IAB-node function that terminates the Uu |
| | interface to the parent node |
| IAB-DU | gNB-DU functionality supported by the |
| | IAB-node to terminate the NR access interface |
| | to UEs and next-hop IAB-nodes, and to terminate |
| | the F1 protocol to the gNB-CU functionality on |
| | the IAB-donor |
| IAB-donor/ | gNB that provides network access to UEs via |
| IAB donor | a network of backhaul and access links |
| Parent | An IAB node or IAB donor that comprises a |
| [IAB] | serving cell of the subject node. In some |
| node | examples, IAB-MT's next hop neighbor node; |
| | the parent node may be an IAB-DU of an IAB-node |
| | or an IAB-donor. |
| Child | An IAB node that identifies the subject node |
| [IAB] | as a serving cell. In some examples, IAB-DU's |
| node | next hop neighbor node; the child node is also |
| | an IAB-node. In some embodiments, a UE or an |
| | enhanced UE or an IAB-enhanced UE may perform |
| | similarly to a child IAB node. |
| Sibling | An IAB node that has a common parent with |
| [IAB] node | the subject node |
| Uplink (of a | A link from an MT to a DU of a parent node |
| wireless backhaul | |
| link) | |
| Downlink (of a | A link from a DU to an MT of a child node |
| wireless backhaul | |
| link) | |
| Upstream | A node/link/etc. (topologically) closer to |
| node/link/etc. | the IAB donor/core network. Direction toward a |
| | parent node in an IAB topology. |
| Downstream | A node/link/etc. (topologically) farther from |
| node/link/etc. | the IAB donor/core network. Direction toward a |
| | child node or UE in an IAB topology. |

In certain embodiments, an “operation” or a “communication” may refer to a transmission or a reception in an uplink (or upstream) or a downlink (or downstream). Furthermore, the terms “simultaneous operation” or “simultaneous communications” may refer to multiplexing and/or duplexing transmissions and/or receptions by a node through one or more antennas and/or panels. Simultaneous operation, if not described explicitly, may be understood from the context.

In some embodiments, multiple slot formats may be used to allow higher flexibility.

In some embodiments, resources may be configured as hard (“H”), soft (“S”), or not available (“NA”). Hard resources may be assumed available for scheduling by an IAB node and NA resources may not be assumed available, while soft resources may be indicated available or not available dynamically. A dynamic availability indication (“AI”) for soft resources may be performed by DCI format 2_5 from a parent IAB node and/or donor, and may have similarities in formats and definitions with SFI (e.g., DCI format 2_0).

In various embodiments, resources may be shared between backhaul and access links, which may be configured semi-statically by a CU (e.g., IAB donor at layer-3) or dynamically by DU (e.g., parent IAB node at layer-1). Multiplexing between backhaul link and access link resources may be TDM, frequency division multiplexing (“FDM”), or may allow time-frequency resource sharing. Furthermore, resources may be allocated exactly (e.g., per node or per link) or in the form of a resource pool.

In certain embodiments, semi-static configuration at layer-2 or layer-3 may be allowed for sharing resources between backhaul and access. It should be noted that an emphasis may be on configuration of resources for backhaul verses access rather than upstream verses downstream. However, under dynamic scheduling, an IAB node can use resources not used by the parent IAB node for backhaul to schedule the access link.

In some embodiments, semi-static verses dynamic resource coordination may be used. In various embodiments, flexible (“F”) may be used in DCI 2_0 and a state access (“A”) for determining slot format and sharing resources may use an access link.

In certain embodiments, an IAB system may be connected to a core network through one or more IAB donors. Further, each IAB node may be connected to an IAB donor and/or other IAB nodes through wireless backhaul links. Each IAB donor and/or node may also serve UEs.

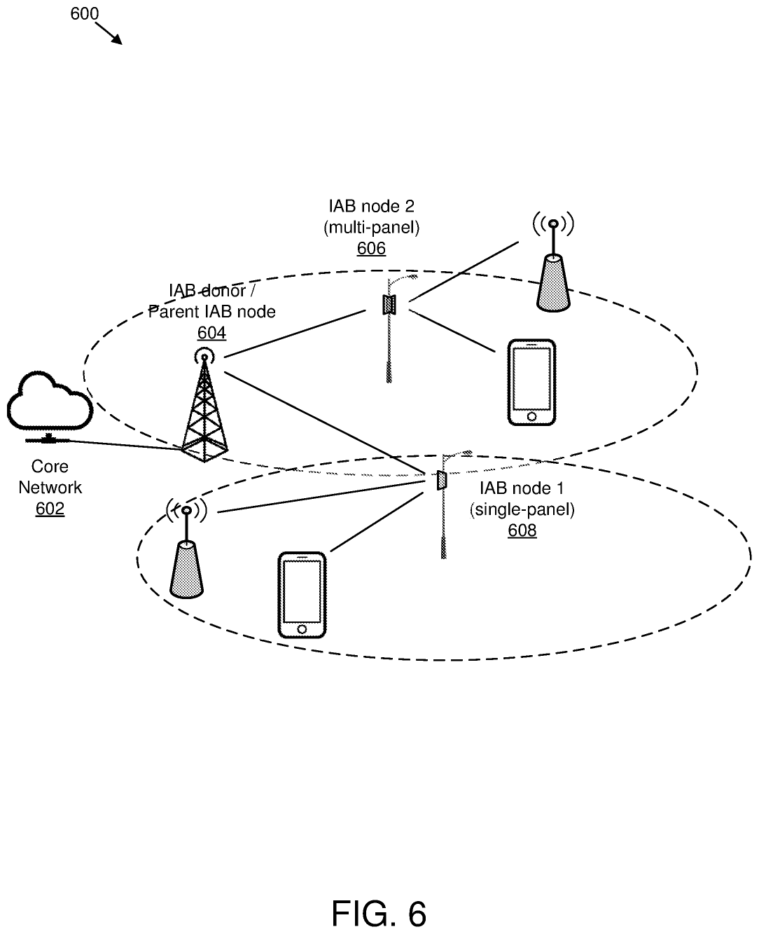

FIG. 6 is a schematic block diagram illustrating one embodiment of an IAB system 600 with single-panel and multi-panel IAB nodes. The IAB system 600 includes a core network 602, an IAB donor and/or parent IAB node 604, an IAB node 2 (e.g., multi-panel) 606, and an IAB node 1 (e.g., single-panel) 608.

There are various options with regards to the structure and multiplexing and/or duplexing capabilities of an IAB node. For example, each IAB node may have one or may antenna panels, each connected to the baseband unit through a radio frequency (“RF”) chain. The one or may antenna panels may be able to serve a wide spatial area of interest in a vicinity of the IAB node, or otherwise each antenna panel or each group of antenna panels may provide a partial coverage such as a “sector.” An IAB node with multiple antenna panels, each serving a separate spatial area or sector, may still be referred to as a single-panel IAB node as it behaves similarly to a single-panel IAB node for communications in each of the separate spatial areas or sectors.

In some embodiments, each antenna panel may be half-duplex (“HD”), meaning that it is able to either transmit or receive signals in a frequency band at a time, or full-duplex (“FD”), meaning that it is able to both transmit and receive signals in a frequency band simultaneously. Unlike full-duplex radio, half-duplex radio is widely implemented and used in practice and may be assumed to be a default mode of operation in wireless systems.

Table 2 lists different duplexing scenarios of interest if multiplexing is not constrained to time-division multiplexing (“TDM”). In Table 2, single-panel and multi-panel IAB nodes are considered for different cases of simultaneous transmission and/or reception. Spatial-division multiplexing (“SDM”) may refer to either transmission or reception on downlink (or downstream) and uplink (or upstream) simultaneously: full duplex (“FD”) may refer to simultaneous transmission and reception by a same antenna panel in a frequency band; and multi-panel transmission and reception (“MPTR”) may refer to simultaneous transmission and/or reception by multiple antenna panels where each antenna panel either transmits or receives in a frequency band at a time.

TABLE 2

| | Architecture/ | Simultaneous | | | Scenar- |
|---|---|---|---|---|---|
| Case# | Capability | TX/RX Type | IAB-MT | IAB-DU | io# |
| Case A/ | Single-panel | TX SDM | UL-TX | DL-TX | S3 |
| Case#1 | Multi-panel | TX | UL-TX | DL-TX | S7 |
| | | MPTR/SDM | | | |
| Case B/ | Single-panel | RX SDM | DL-RX | UL-RX | S1 |
| Case#2 | Multi-panel | RX | DL-RX | UL-RX | S5 |
| | | MPTR/SDM | | | |
| Case C/ | Single-panel | UL FD | UL-TX | UL-RX | S4 |
| Case#3 | Multi-panel | UL | UL-TX | UL-RX | S8 |
| | | MPTR/FD | | | |
| Case D/ | Single-panel | DL FD | DL-RX | DL-TX | S2 |
| Case#4 | Multi-panel | DL | DL-RX | DL-TX | S6 |
| | | MPTR/FD | | | |

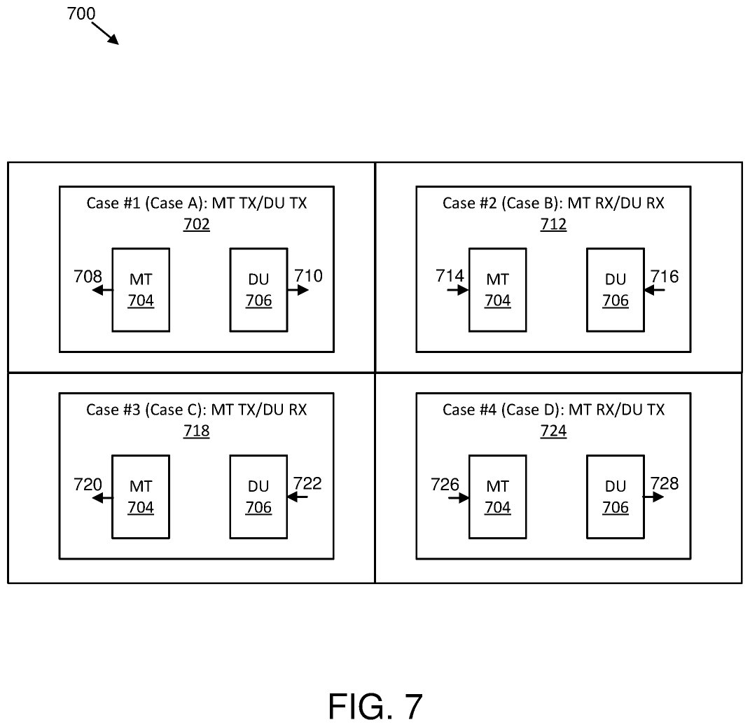

In Table 2, based on a type of simultaneous operations and a number of panels in an IAB node, the scenarios are called S1, S2, . . . , S8, while the “Case” numbers (e.g., A/B/C/D or 1/2/3/4) may be in accordance with FIG. 7.

FIG. 7 is a schematic block diagram 700 illustrating one embodiment of types of simultaneous transmission and/or reception operations. The diagram 700 illustrates a first case 702 (e.g., Case #1, Case A, MT TX and DU TX) having an MT 704 and a DU 706, in which the MT 704 transmits 708 and the DU 706 transmits 710. Moreover, the diagram 700 illustrates a second case 712 (e.g., Case #2, Case B, MT RX and DU RX) having the MT 704 and the DU 706, in which the MT 704 receives 714 and the DU 706 receives 716. Further, the diagram 700 illustrates a third case 718 (e.g., Case #3, Case C, MT TX and DU RX) having the MT 704 and the DU 706, in which the MT 704 transmits 720 and the DU 706 receives 722. The diagram 700 illustrates a fourth case 724 (e.g., Case #4, Case D, MT RX and DU TX) having the MT 704 and the DU 706, in which the MT 704 receives 726 and the DU 706 transmits 728. As used herein, different cases may be referred to by the case #, case letter, or description as found in FIG. 7.

In various embodiments, there may be PHR signaling.

In certain embodiments, there may be a power headroom report defined as found herein. The types of UE power headroom reports are the following. A Type 1 UE power headroom PH that is valid for physical uplink shared channel (“PUSCH”) transmission occasion i on active UL bandwidth part (“BWP”) b of carrier f of serving cell c. A Type 3 UE power headroom PHI that is valid for SRS transmission occasion i on active UL BWP b of carrier f of serving cell c

In some embodiments, a UE determines whether a power headroom report for an activated serving cell is based on an actual transmission or a reference format based on the higher layer signaling of configured grant and periodic and/or semi-persistent sounding reference signal transmissions and downlink control information the UE received until and including the physical downlink control channel (“PDCCH”) monitoring occasion where the UE detects the first DCI format scheduling an initial transmission of a transport block since a power headroom report was triggered if the power headroom report is reported on a PUSCH triggered by the first DCI format. Otherwise, a UE determines whether a power headroom report is based on an actual transmission or a reference format based on the higher layer signaling of configured grant and periodic and/or semi-persistent sounding reference signal transmissions and downlink control information the UE received until the first uplink symbol of a configured PUSCH transmission minus T′_{proc,2}=T_{proc,2} where T_{proc,2} is determined assuming d_{2,1}=1, d_{2,2}=0, and with μ_{DL} corresponding to the subcarrier spacing of the active downlink BWP of the scheduling cell for a configured grant if the power headroom report is reported on the PUSCH using the configured grant.

If a UE is configured with two UL carriers for a serving cell and determines a Type 1 power headroom report and a Type 3 power headroom report for the serving cell, the UE provides the Type 1 power headroom report if both the Type 1 and Type 3 power headroom reports are based on respective actual transmissions or on respective reference transmissions and provides the power headroom report that is based on a respective actual transmission if either the Type 1 report or the Type 3 report is based on a respective reference transmission.

If a UE is configured with a SCG and if phr-ModeOtherCG for a CG indicates ‘virtual’, then, for power headroom reports transmitted on the CG, the UE computes PH assuming that the UE does not transmit PUSCH and/or physical uplink control channel (“PUCCH”) on any serving cell of the other CG. For NR-DC, when both the MCG and the SCG operate either in FR1 or in FR2 and for a power headroom report transmitted on the MCG or the SCG, the UE computes PH assuming that the UE does not transmit PUSCH/PUCCH on any serving cell of the SCG or the MCG, respectively.

If the UE is configured with a SCG: 1) for computing power headroom for cells belonging to MCG, the term ‘serving cell’ in this clause refers to serving cell belonging to the MCG; and 2) for computing power headroom for cells belonging to SCG, the term ‘serving cell’ in this clause refers to serving cell belonging to the SCG. The term ‘primary cell’ in this clause refers to the PSCell of the SCG.

If the UE is configured with a PUCCH-SCell: 1) for computing power headroom for cells belonging to primary PUCCH group, the term ‘serving cell’ in this clause refers to serving cell belonging to the primary PUCCH group; and 2) for computing power headroom for cells belonging to secondary PUCCH group, the term ‘serving cell’ in this clause refers to serving cell belonging to the secondary PUCCH group. The term ‘primary cell’ in this clause refers to the PUCCH-SCell of the secondary PUCCH group.

For a UE configured with EN-DC/NE-DC and capable of dynamic power sharing, if E-UTRA Dual Connectivity PHR is triggered and: 1) if the duration of NR slot on active UL BWP is different from that of E-UTRA subframe carrying the Dual Connectivity PHR, the UE provides power headroom of the first NR slot that fully overlaps with the E-UTRA subframe; and 2) if the duration of NR slot on active UL BWP is the same as that of E-UTRA subframe carrying the Dual Connectivity PHR for asynchronous EN-DC and/or NE-DC, the UE provides power headroom of the first NR slot that overlaps with the E-UTRA subframe.

In various embodiments, there may be a Type 1 PH report. If a UE determines that a Type 1 power headroom report for an activated serving cell is based on an actual PUSCH transmission then, for PUSCH transmission occasion i on active UL BWP b of carrier f of serving cell c, the UE computes the Type 1 power headroom report as:

$${PH}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) [ dB ]$$

where P_{CMAXf}(i), P_{O_PUSCHb,f,c}(j), M_{RB,b,f,c}^{PUSCH}(i), α_{b,f,c}(j), PL_{b,f,c}(q_{d}), Δ_{TF,b,f,c}(i) and f_{b,f,c}(i,l) are defined.

If a UE is configured with multiple cells for PUSCH transmissions, where a subcarrier spacing (“SCS”) configuration μ₁ on active UL BWP b₁ of carrier f₁ of serving cell c₁ is smaller than a SCS configuration μ₂ on active UL BWP b₂ of carrier f₂ of serving cell c₂, and if the UE provides a Type 1 power headroom report in a PUSCH transmission in a slot on active UL BWP b₁ that overlaps with multiple slots on active UL BWP b₂, the UE provides a Type 1 power headroom report for the first PUSCH, if any, on the first slot of the multiple slots on active UL BWP b₂ that fully overlaps with the slot on active UL BWP b₁. If a UE is configured with multiple cells for PUSCH transmissions, where a same SCS configuration on active UL BWP b₁ of carrier f₁ of serving cell c₁ and active UL BWP b₂ of carrier f₂ of serving cell c₂, and if the UE provides a Type 1 power headroom report in a PUSCH transmission in a slot on active UL BWP b₁, the UE provides a Type 1 power headroom report for the first PUSCH, if any, on the slot on active UL BWP b₂ that overlaps with the slot on active UL BWP b₁.

If a UE is configured with multiple cells for PUSCH transmissions and provides a Type 1 power headroom report in a PUSCH transmission with PUSCH repetition Type B having a nominal repetition that spans multiple slots on active UL BWP b, and overlaps with one or more slots on active UL BWP b₂, the UE provides a Type 1 power headroom report for the first PUSCH, if any, on the first slot of the one or more slots on active UL BWP b₂ that overlaps with the multiple slots of the nominal repetition on active UL BWP b₁.

For a UE configured with EN-DC and/or NE-DC and capable of dynamic power sharing, if E-UTRA Dual Connectivity PHR is triggered, the UE provides power headroom of the first PUSCH, if any, on the determined NR slot.

If a UE is configured with multiple cells for PUSCH transmissions, the UE does not consider for computation of a Type 1 power headroom report in a first PUSCH transmission that includes an initial transmission of transport block on active UL BWP b, of carrier f₁ of serving cell c₁, a second PUSCH transmission on active UL BWP b₂ of carrier f, of serving cell c₂ that overlaps with the first PUSCH transmission if: 1) the second PUSCH transmission is scheduled by a DCI format in a PDCCH received in a second PDCCH monitoring occasion; and 2) the second PDCCH monitoring occasion is after a first PDCCH monitoring occasion where the UE detects the earliest DCI format scheduling an initial transmission of a transport block after a power headroom report was triggered: or 3) the second PUSCH transmission is after the first uplink symbol of the first PUSCH transmission minus T′_{proc,2}=T_{proc,2} where T_{proc,2} is determined assuming d_{2,1}=1, d_{2,2}=0, and with μ_{DL} corresponding to the subcarrier spacing of the active downlink BWP of the scheduling cell for a configured grant if the first PUSCH transmission is on a configured grant after a power headroom report was triggered.

If the UE determines that a Type 1 power headroom report for an activated serving cell is based on a reference PUSCH transmission then, for PUSCH transmission occasion i on active UL BWP b of carrier f of serving cell c, the UE computes the Type 1 power headroom report as:

PH_{typeb,f,c}(i,j,q_{d},l)=\tilde{P}_{CMAX,f,c}(i)−{P_{O_PUSCHb,f,c}(j)+a_{b,f,c}(j)·PL_{b,f,c}(q_{d})+f_{b,f,c}(i,l)}[dB]

where \tilde{P}_{CMAXf,c} (i) is computed assuming maximum power reduction (“MPR”)=0 dB. A-MPR=0 dB, P-MPR=0 dB. ΔT_{C}=0 dB. MPR, A-MPR, P-MPR and ΔT_{C} are defined. The remaining parameters are defined where P_{O_PUSCHb,f,c}. (j) and . . . a_{b,f,c}(j) are obtained using P_{O_NOMINAL PUSCH.fc} (0) and p0-PUSCH-AlphaSetld=0, PLb.f. (qa) is obtained using pusch-PathlossReferenceRS-Id=0, and l=0.

If a UE is configured with two UL carriers for a serving cell and the UE determines a Type 1 power headroom report for the serving cell based on a reference PUSCH transmission, the UE computes a Type 1 power headroom report for the serving cell assuming a reference PUSCH transmission on the UL carrier provided by pusch-Config. If the UE is provided pusch-Config for both UL carriers, the UE computes a Type 1 power headroom report for the serving cell assuming a reference PUSCH transmission on the UL carrier provided by pucch-Config. If pucch-Config is not provided to the UE for any of the two UL carriers, the UE computes a Type 1 power headroom report for the serving cell assuming a reference PUSCH transmission on the non-supplementary UL carrier.

In some embodiments, there is a Type 2 PH report.

In various embodiments, there is a Type 3 PH report. If a UE determines that a Type 3 power headroom report for an activated serving cell is based on an actual SRS transmission then, for SRS transmission occasion i on active UL BWP b of carrier f of serving cell c and if the UE is not configured for PUSCH transmissions on carrier f of serving cell c and the resource for the SRS transmission is provided by SRS-Resource, the UE computes a Type 3 power headroom report as:

$${PH}_{type 3 , b , f , c} ( i , {q}_{s} ) = {P}_{CMAX , f , c} ( i ) - \{ {P}_{O \_ SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i \text{?} [ dB ]$$

$$\text{?} \text{indicates text missing or illegible when filed}$$

where P_{CMAX,f,c}(i), P_{O_SRSb,f,c}(q), M_{SRSb,f,c}(i); a_{SRSb,f,c}(qₛ), PL_{b,f,c}(q_{d}) and h_{b,f,c}(i) are defined with corresponding values provided by SRS-ResourceSet.

If the UE determines that a Type 3 power headroom report for an activated serving cell is based on a reference SRS transmission then, for SRS transmission occasion i on UL BWP b of carrier f of serving cell c, and if the UE is not configured for PUSCH transmissions on UL BWP b of carrier f of serving cell c and a resource for the reference SRS transmission is provided by SRS-Resource, the UE computes a Type 3 power headroom report as:

$${PH}_{type 3 , b , f , c} ( i , {q}_{s} ) = {\tilde{P}}_{CMAX , f , c} ( i ) - \{ {P}_{O \_ SRS , b , f , c} ( {q}_{s} ) + {α}_{SRS , b , f , c} ( {q}_{s} ) \cdot {PL}_{b , f , c} ( {q}_{d} ) + {h}_{b , f , c} ( i ) \} [ dB ]$$

where qₛ is an SRS resource set corresponding to SRS-ResourceSetld=0 for UL BWP b and P_{O_SRSb,f,c}(qₛ), a_{SRS,f,c}(qₛ), PL_{b,f,c}(q_{d}) and h_{b,f,c}(i) are defined with corresponding values obtained from SRS-ResourceSetId=0 for UL BWP b. \tilde{P}_{CMAXf,c}(i) is computed assuming MPR=0 dB, A-MPR=0 dB, P-MPR=0 dB and ΔT_{C}=0 dB. MPR, A-MPR, P-MPR and ΔT_{C} are defined.

If a UE is configured with two UL carriers for a serving cell and the UE determines a Type 3 power headroom report for the serving cell based on a reference SRS transmission and a resource for the reference SRS is provided by SRS-Resource, the UE computes a Type 3 power headroom report for the serving cell assuming a reference SRS transmission on the UL carrier provided by pucch-Config. 1f pucch-Config is not provided to the UE for any of the two UL carriers, the UE computes a Type 3 power headroom report for the serving cell assuming a reference SRS transmission on the non-supplementary UL carrier.

In various embodiments, there may be power headroom reporting. The power headroom reporting procedure is used to provide the serving gNB with the following information: 1) Type 1 power headroom: the difference between the nominal UE maximum transmit power and the estimated power for UL shared channel (“SCH”) (“UL-SCH”) transmission per activated serving cell: 2) Type 2 power headroom: the difference between the nominal UE maximum transmit power and the estimated power for UL-SCH and PUCCH transmission on SpCell of the other MAC entity (e.g., E-UTRA MAC entity in EN-DC, NE-DC, and NGEN-DC cases): 3) Type 3 power headroom: the difference between the nominal UE maximum transmit power and the estimated power for SRS transmission per activated serving cell; and 4) maximum permissible exposure (“MPE”) P-MPR: the power backoff to meet the MPE FR2 requirements for a Serving Cell operating on FR2.

In certain embodiments, RRC controls power headroom reporting by configuring the following parameters: 1) phr-PeriodicTimer: 2) phr-ProhibitTimer: 3) phr-Tx-PowerFactorChange: 4) phr-Type2OtherCell: 5) phr-ModeOtherCG: 6) multiplePHR: 7) mpe-Reporting-FR2: 8) mpe-ProhibitTimer; and/or 9) mpe-Threshold.

In some embodiments, a power headroom report (“PHR”) may be triggered if any of the following events occur: 1) phr-ProhibitTimer expires or has expired and the path loss has changed more than phr-Tx-PowerFactorChange dB for at least one activated serving cell of any MAC entity of which the active DL BWP is not dormant BWP which is used as a pathloss reference since the last transmission of a PHR in this MAC entity when the MAC entity has UL resources for new transmission (it should be noted that the path loss variation for one cell assessed above is between the pathloss measured at present time on the current pathloss reference and the pathloss measured at the transmission time of the last transmission of PHR on the pathloss reference in use at that time, irrespective of whether the pathloss reference has changed in between—the current pathloss reference for this purpose does not include any pathloss reference configured using pathlossReferenceRS-Pos): 2) phr-PeriodicTimer expires: 3) upon configuration or reconfiguration of the power headroom reporting functionality by upper layers, which is not used to disable the function: 4) activation of an SCell of any MAC entity with configured uplink of which firstActiveDownlinkBWP-Id is not set to dormant BWP: 5) addition of the PSCell (e.g., PSCell is newly added or changed): 6) phr-ProhibitTimer expires or has expired, when the MAC entity has UL resources for new transmission, and the following is true for any of the activated Serving Cells of any MAC entity with configured uplink: there are UL resources allocated for transmission or there is a PUCCH transmission on this cell, and the required power backoff due to power management (as allowed by P-MPRc) for this cell has changed more than phr-Tx-PowerFactorChange dB since the last transmission of a PHR when the MAC entity had UL resources allocated for transmission or PUCCH transmission on this cell: 7) upon switching of activated BWP from dormant BWP to non-dormant DL BWP of an SCell of any MAC entity with configured uplink: 8) if mpe-Reporting-FR2 is configured, and mpe-ProhibitTimer is not running: a) the measured P-MPR applied to meet FR2 MPE requirements is equal to or larger than mpe-Threshold for at least one activated FR2 Serving Cell since the last transmission of a PHR in this MAC entity, or b) the measured P-MPR applied to meet FR2 MPE requirements has changed more than phr-Tx-PowerFactorChange dB for at least one activated FR2 serving cell since the last transmission of a PHR due to the measured P-MPR applied to meet MPE requirements being equal to or larger than mpe-Threshold in this MAC entity, in which case the PHR is referred below to as ‘MPE P-MPR report’. It should be noted that the MAC entity should avoid triggering a PHR when the required power backoff due to power management decreases only temporarily (e.g., for up to a few tens of milliseconds) and it should avoid reflecting such temporary decrease in the values of P_{CMAX,f,c}/PH when a PHR is triggered by other triggering conditions.

It should also be noted that, if a HARQ process is configured with cg-RetransmissionTimer and if the PHR is already included in a MAC protocol data unit (“PDU”) for transmission by this HARQ process, but not yet transmitted by lower layers, it is up to UE implementation how to handle the PHR content.

If the MAC entity has UL resources allocated for a new transmission the MAC entity may:
1> if it is the first UL resource allocated for a new transmission since the last MAC reset: 2> start phr-PeriodicTimer:
2> if the power headroom reporting procedure determines that at least one PHR has been triggered and not cancelled; and
1> if the allocated UL resources can accommodate the MAC CE for PHR which the MAC entity is configured to transmit, plus its subheader, as a result of logical channel prioritization (“LCP”):
2> if multiplePHR with value true is configured:
3> for each activated Serving Cell with configured uplink associated with any
MAC entity of which the active DL BWP is not dormant BWP:
4> obtain the value of the Type 1 or Type 3 power headroom for the corresponding uplink carrier for NR serving cell or for E-UTRA serving cell:
4> if this MAC entity has UL resources allocated for transmission on this serving cell: or
4> if the other MAC entity, if configured, has UL resources allocated for transmission on this serving cell and phr-ModeOtherCG is set to real by upper layers:
5> obtain the value for the corresponding P_{CMAX,f,c} field from the physical layer.
5> if mpe-Reporting-FR2 is configured and this Serving Cell operates on FR2 and this Serving Cell is associated to this MAC entity:
6> obtain the value for the corresponding MPE field from the physical layer. 3> if phr-Type 2OtherCell with value true is configured:
4> if the other MAC entity is E-UTRA MAC entity:
5> obtain the value of the Type 2 power headroom for the SpCell of the other MAC entity (e.g., E-UTRA MAC entity);
5> if phr-ModeOtherCG is set to real by upper layers:
6> obtain the value for the corresponding P_{CMAX,f,c} field for the SpCell of the other MAC entity (e.g., E-UTRA MAC entity) from the physical layer.
3> instruct the multiplexing and assembly procedure to generate and transmit the multiple entry PHR MAC control element (“CE”) based on the values reported by the physical layer.
2> else (e.g., single entry PHR format is used):
3> obtain the value of the Type 1 power headroom from the physical layer for the corresponding uplink carrier of the PCell;
3> obtain the value for the corresponding P_{CMAX,f,c} field from the physical layer:
3> if mpe-Reporting-FR2 is configured and this serving cell operates on FR2:
4> obtain the value for the corresponding MPE field from the physical layer.
3> instruct the Multiplexing and Assembly procedure to generate and transmit the Single Entry PHR MAC CE based on the values reported by the physical layer.
2> if this PHR report is an MPE P-MPR report:
3> start or restart the mpe-ProhibitTimer:
3> cancel triggered MPE P-MPR reporting for serving cells included in the PHR MAC CE.
2> start or restart phr-PeriodicTimer:
2> start or restart phr-ProhibitTimer:
2> cancel all triggered PHR(s).

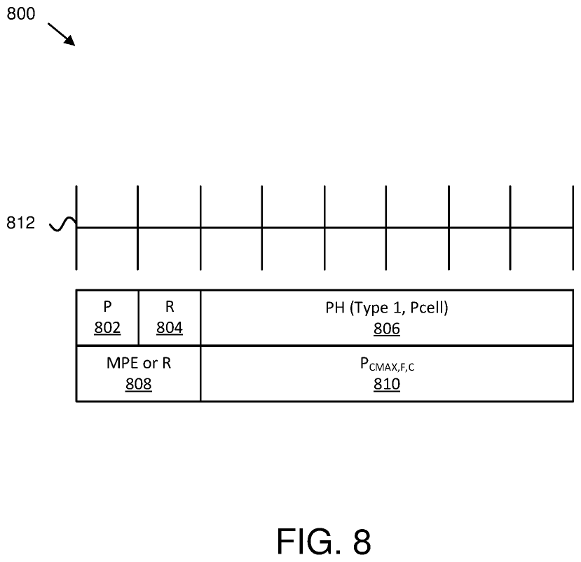

In certain embodiments, there may be single entry PHR MAC CE. The single entry PHR MAC CE is identified by a MAC subheader with a logical channel identifier (“ID”) (“LCID”). It has a fixed size and consists of two octets defined as follows (e.g., as shown in FIG. 8).

Specifically, FIG. 8 is a block diagram illustrating one embodiment of a single entry PHR MAC CE 800. The PHR MAC CE 800 includes P 802, R 804, power headroom (“PH”) 806, MPE or R 808, and P_{CMAX,f,c} 810 across bits 812. The R 804 is a reserved bit set to 0. The PH 806 field indicates the power headroom level. The length of the field is 6 bits. The reported PH 806 and the corresponding power headroom levels are shown in Table 3 (e.g., the corresponding measured values in dB).

The P 802, if mpe-Reporting-FR2 is configured and the serving cell operates on FR2, the MAC entity shall set this field to 0 if the applied P-MPR value to meet MPE requirements is less than P-MPR_00 and to 1 otherwise. If mpe-Reporting-FR2 is not configured or the serving cell operates on FR1, this field indicates whether power backoff is applied due to power management (e.g., as allowed by P-MPRc). The MAC entity shall set the P 802 field to 1 if the corresponding P_{CMAX,f,c} 810 field would have had a different value if no power backoff due to power management had been applied. The P_{CMAX,f,c} 810 field indicates the P_{CMAX,f,c} 810 used for calculation of the preceding PH 806 field. The reported P_{CMAX,f,c} 810 and the corresponding nominal UE transmit power levels are shown in Table 4 (e.g., the corresponding measured values in dBm).

The MPE 808, if mpe-Reporting-FR2 is configured and the serving cell operates on FR2, and if the P 802 field is set to 1, this field indicates the applied power backoff to meet MPE 808 requirements. This field indicates an index to Table 5 and the corresponding measured values of P-MPR levels in dB. The length of the field is 2 bits. If mpe-Reporting-FR2 is not configured, or if the Serving Cell operates on FR1, or if the P 802 field is set to 0. R bits are present instead.

TABLE 3
Power Headroom levels for PHR

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |
| . . . | . . . |
| 60 | POWER_HEADROOM_60 |
| 61 | POWER_HEADROOM_61 |
| 62 | POWER_HEADROOM_62 |
| 63 | POWER_HEADROOM_63 |

TABLE 4
Nominal UE transmit power level for PHR

| P_{CMAX, f, c} | Nominal UE transmit power level |
|---|---|
| 0 | PCMAX_C_00 |
| 1 | PCMAX_C_01 |
| 2 | PCMAX_C_02 |
| . . . | . . . |
| 61 | PCMAX_C_61 |
| 62 | PCMAX_C_62 |
| 63 | PCMAX_C_63 |

TABLE 5
Effective power reduction for MPE P-MPR

| MPE | Measured P-MPR value |
|---|---|
| 0 | P-MPR_00 |
| 1 | P-MPR_01 |
| 2 | P-MPR_02 |
| 3 | P-MPR_03 |

In some embodiments, there may be a multiple entry PHR MAC CE. The Multiple Entry PHR MAC CE may be identified by a MAC subheader with a LCID. It has a variable size, and includes the bitmap, a Type 2 PH field, and an octet containing the associated P_{CMAX,f,c} field (e.g., if reported) for SpCell of the other MAC entity, a Type 1 PH field and an octet containing the associated P_{CMAX,f,c} field (e.g., if reported) for the PCell. It further includes, in ascending order based on the ServCellIndex, one or more of Type X PH fields and octets containing the associated P_{CMAX,f,c} fields (e.g., if reported) for serving cells other than PCell indicated in the bitmap. X is either 1 or 3. The presence of Type 2 PH field for SpCell of the other MAC entity is configured by phr-Type 2OtherCell with value true.

A single octet bitmap is used for indicating the presence of PH per Serving Cell when the highest ServCellIndex of serving cell with configured uplink is less than 8, otherwise four octets are used.

The MAC entity determines whether PH value for an activated serving cell is based on real transmission or a reference format by considering the configured grants and downlink control information which has been received until and including the PDCCH occasion in which the first UL grant for a new transmission that can accommodate the MAC CE for PHR as a result of LCP is received since a PHR has been triggered if the PHR MAC CE is reported on an uplink grant received on the PDCCH or until the first uplink symbol of PUSCH transmission minus PUSCH preparation time if the PHR MAC CE is reported on a configured grant.

For a band combination in which the UE does not support dynamic power sharing, the UE may omit the octets containing power headroom field and P_{CMAX,f,c} field for serving cells in the other MAC entity except for the PCell in the other MAC entity and the reported values of power headroom and P_{CMAX,f,c} for the PCell are up to UE implementation.

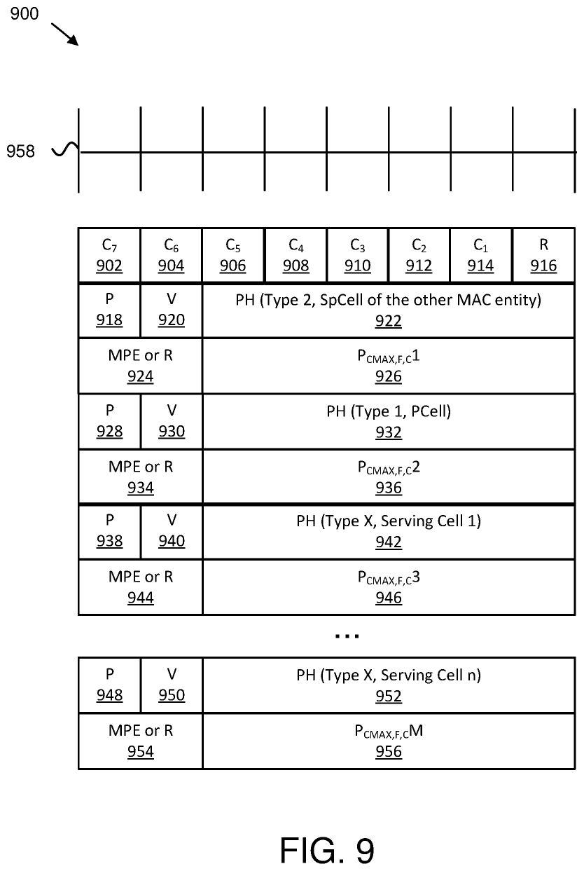

FIG. 9 is a block diagram illustrating one embodiment of a multiple entry PHR MAC CE 900 with the highest ServCellIndex of serving cell with configured uplink is less than 8. The PHR MAC CE 900 includes C₇ 902, C₆ 904, C₅ 906, C₄ 908, C₃ 910, C₂ 912, C₁ 914, R 916, P 918, V 920, PH 922, MPE or R 924, P_{CMAX,f,c1} 926, P 928, V 930, PH 932, MPE or R 934, P_{CMAX,f,c2} 936, P 938, V 940, PH 942, MPE or R 944, P_{CMAX,f,c}3 946, P 948, V 950, PH 952, MPE or R 954, and P_{CMAX,f,c}M 956 across bits 958.

For Cᵢ: this field indicates the presence of a PH field for the serving cell with ServCellIndex i. The Cᵢ field set to 1 indicates that a PH field for the serving cell with ServCellIndex i is reported. The Cᵢ field set to 0 indicates that a PH field for the serving cell with ServCellIndex i is not reported. For each R: there is a reserved bit set to 0. For each V: this field indicates if the PH value is based on a real transmission or a reference format. For Type 1 PH, the V field set to 0 indicates real transmission on PUSCH and the V field set to 1 indicates that a PUSCH reference format is used. For Type 2 PH, the V field set to 0 indicates real transmission on PUCCH and the V field set to 1 indicates that a PUCCH reference format is used. For Type 3 PH, the V field set to 0 indicates real transmission on SRS and the V field set to 1 indicates that an SRS reference format is used. Furthermore, for Type 1, Type 2, and Type 3 PH, the V field set to 0 indicates the presence of the octet containing the associated P_{CMAX,f,c} field and the MPE field, and the V field set to 1 indicates that the octet containing the associated P_{CMAX,f,c} field and the MPE field is omitted.

For each PH: this field indicates the power headroom level. The length of the field is 6 bits. The reported PH and the corresponding power headroom levels (e.g., the corresponding measured values in dB for the NR serving cell are specified while the corresponding measured values in dB for the E-UTRA Serving Cell are specified).

For each P: if mpe-Reporting-FR2 is configured and the serving cell operates on FR2, the MAC entity shall set this field to 0 if the applied P-MPR value, to meet MPE requirements, is less than P-MPR_00 and to 1 otherwise. If mpe-Reporting-FR2 is not configured or the serving cell operates on FR1, this field indicates whether power backoff is applied due to power management (e.g., as allowed by P-MPRc). The MAC entity shall set the P field to 1 if the corresponding P_{CMAX,f,c} field would have had a different value if no power backoff due to power management had been applied.

For each P_{CMAX,f,c}: if present, this field indicates the P_{CMAX,f,c} for the NR serving cell and the P_{CMAX,c} or P_{CMAX,c} for the E-UTRA serving cell used for calculation of the preceding PH field.

For each MPE: if mpe-Reporting-FR2 is configured, and the serving cell operates on FR2, and if the P field is set to 1, this field indicates the applied power backoff to meet MPE requirements. This field indicates an index and the corresponding measured values of P-MPR levels in dB. The length of the field is 2 bits. If mpe-Reporting-FR2 is not configured, or if the serving cell operates on FR1, or if the P field is set to 0, R bits are present instead.

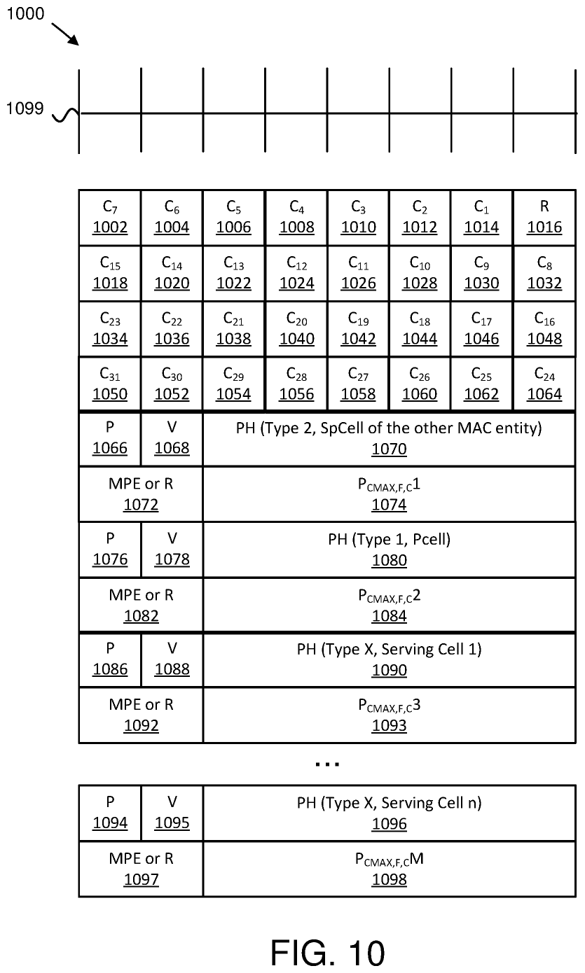

FIG. 10 is a block diagram illustrating another embodiment of a multiple entry PHR MAC CE 1000 with the highest ServCellIndex of serving cell with configured uplink is equal to or higher than 8. The PHR MAC CE 1000 includes C₇ 1002, C₆ 1004, C₅ 1006, C₄ 1008, C₃ 1010, C₂ 1012, C₁ 1014, R 1016, C₁₅ 1018, C₁₄ 1020, C₁₃ 1022, C₁₂ 1024, C₁₁ 1026, C₁₀ 1028, C₉ 1030, C₈ 1032, C₂₃ 1034, C₂₂ 1036, C₂₁ 1038, C₂₀ 1040, C₁₉ 1042, C₁₈ 1044, C₁₇ 1046, C₁₆ 1048, C₃₁ 1050, C₃₀ 1052, C₂₉ 1054, C₂₈ 1056, C₂₇ 1058, C₂₆ 1060, C₂₅ 1062, C₂₄ 1064, P 1066, V 1068, PH 1070, MPE or R 1072, P_{CMAX,f,c} 1 1074, P 1076, V 1078, PH 1080, MPE or R 1082, P_{CMAX,f,c2} 1084, P 1086, V 1088, PH 1090, MPE or R 1092, P_{CMAX,f,c},3 1093, P 1094, V 1095, PH 1096, MPE or R 1097, and P_{CMAX,f,c}M 1098 across bits 1099.

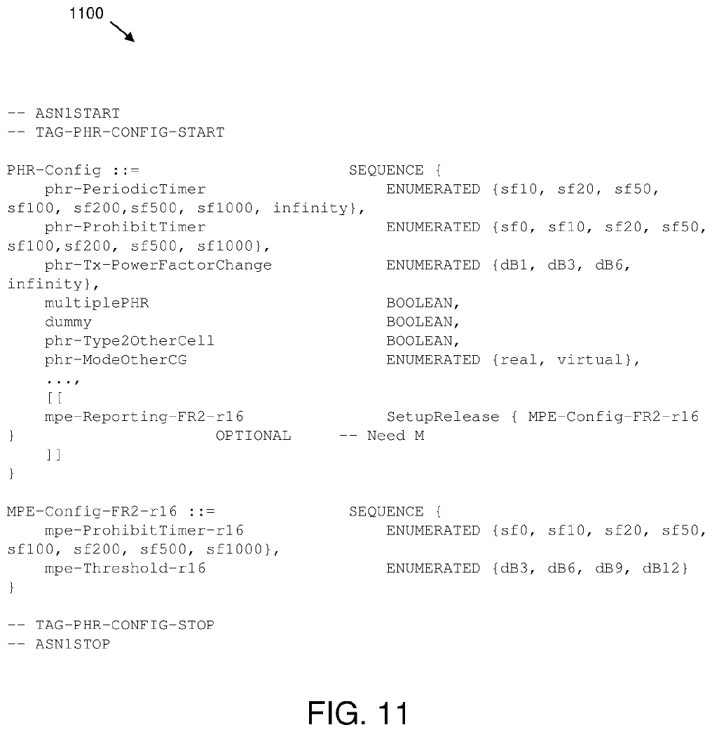

In various embodiments, there may be a PHR-Config. FIG. 11 is a code diagram illustrating one embodiment of a PHR-Config information element (“IE”) 1100. The PHR-Config 1E 1100 is used to configure parameters for power headroom reporting based on Table 6.

TABLE 6
dummy
This field is not used in this version of the specification and
the UE ignores the received value.
mpe-ProhibitTimer
Value in number of subframes for MPE reporting. Value
sf10 corresponds to 10 subframes, and so on.
mpe-Reporting-FR2
Indicates whether the UE shall report MPE P-MPR in the
PHR MAC control element.
mpe-Threshold
Value of the P-MPR threshold in dB for reporting MPE P-MPR
when FR2 is configured. The same value applies for each
serving cell (although the associated functionality is
performed independently for each cell).
multiplePHR
Indicates if power headroom shall be reported using the
Single Entry PHR MAC control element or Multiple Entry
PHR MAC control element. True means to use Multiple Entry PHR
MAC control element and False means to use the Single Entry
PHR MAC control element. The network configures this field to
true for MR-DC and UL carrier aggregation (“CA”) for
NR, and to false in all other cases.
phr-ModeOtherCG
Indicates the mode (i.e. real or virtual) used for the PHR
of the activated cells that are part of the other Cell Group (i.e.
master cell group (“MCG”) or secondary cell group (“SCG”)), when
DC is configured. If the UE is configured with only one cell group
(no DC), it ignores the field.
phr-PeriodicTimer
Value in number of subframes for PHR reporting. Value sf10
corresponds to 10 subframes, value sf20 corresponds to 20 subframes,
and so on.
phr-ProhibitTimer
Value in number of subframes for PHR reporting. Value sf0 corresponds
to 0 subframe, value sf10 corresponds to 10 subframes, value sf20
corresponds to 20 subframes, and so on.
phr-Tx-PowerFactorChange
Value in dB for PHR reporting. Value dB1 corresponds to 1 dB, dB3
corresponds to 3 dB and so on. The same value applies for each
serving cell (although the associated functionality is performed
independently for each cell).
phr-Type2OtherCell
If set to true, the UE shall report a PHR type 2 for the SpCell
of the other MAC entity. Network sets this field to false if
the UE is not configured with an E-UTRA MAC entity.

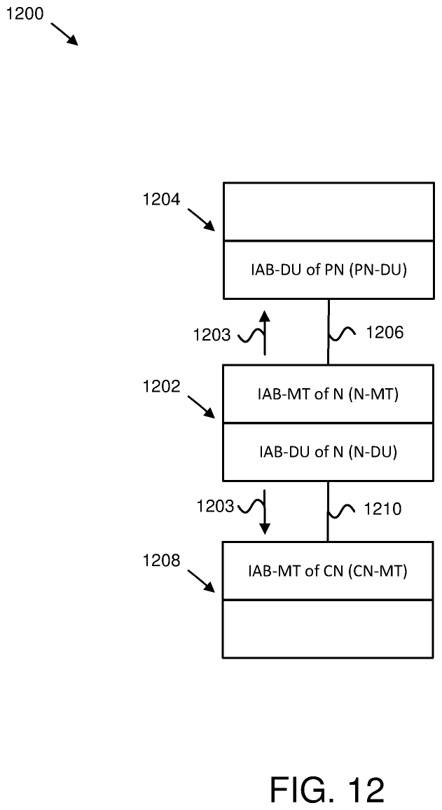

FIG. 12 is a block diagram illustrating one embodiment of a system 1200 including a subject IAB node (N) 1202 performing transmissions 1203 to a parent node or IAB donor (PN) 1204 in the IAB node's upstream via an upstream link 1206 and a child node or UE 1208 in the IAB node's downstream link 1210.

In FIG. 12, the IAB node 1202 transmits signals to the parent IAB node and/or donor 1204 and the child IAB node or UE 1208.

In some embodiments: 1) the IAB node 1202 may be connected to multiple parent nodes and/or child nodes/UEs: 2) the IAB node 1202 may comprise multiple IAB-MTs and/or multiple IAB-DUs: 3) the parent node 1204, the LAB node 1202, and the child node 1208 may be referred to as PN, N, and CN, respectively; and 4) an IAB-DU or PN, an IAB-MT of N, an IAB-DU of N, and an IAB-MT of CN may be referred to as PN-DU, N-MT, N-DU, and CN-MT, respectively.

In various embodiments, there may be methods and systems for enhanced power headroom reporting. In certain embodiments, a PHR transmission from an IAB node N to a parent node PN is triggered by an event that is related to the downstream of the IAB node (e.g., related to a cell provided by N-DU or a link between N-DU and CN-MT). If the event is related to N-DU without a reference to a specific child node or UE served by N-DU, the method may be referred to as “per-cell” or “cell-based.” However, if the event is related to a link between N-DU and a specific child node CN-MT or UE, the method may be referred to as “per-link” or “link-based.” As found herein, descriptions of some embodiments may be articulated in per-cell or per-link language. However, that is not to limit the scope and, in some realizations, a per-link method may be realized on a per-cell basis or vice versa, even if not explicitly mentioned in the embodiments.

In some embodiments, a power control parameter for computing a value of power headroom or a value of power headroom offset or the like may be determined based on a parameter or event related to a downstream cell or link of an IAB node N. For example, a value of P_{c,max} for an UL transmission from N to a parent node (PN-DU) may change due to a change in a downstream link (between N-DU and CN-MT) or cell (provided by N-DU). Then, this change may trigger a PHR transmission or another transmission to the parent node (PN-DU) or, alternatively, to an IAB-CU.

In various embodiments, an event or parameter related to a downstream link or cell of an IAB node may follow a signaling or another action by a parent node of the IAB node. In certain embodiments, a first parent node that performs the signaling or another action may be different from a second parent node of the IAB node to which the power headroom or other power control parameter is associated.

In certain embodiments, there may be PHR triggering events. In some embodiments, PHR signaling from N-MT to PN-DU is triggered based on an event related to N-DU.

In various embodiments, N-MT may transmit a PHR to PN-DU upon N-DU receiving a DL power adjustment message from CN-MT. In such embodiments, the PHR may include a value of PH that is determined based on a value of power adjustment in the power adjustment message.

In certain embodiments, if N-DU receives a DL power adjustment message from CN-MT, N may determine whether N-DU applies a power adjustment in response to the message. If affirmative, N-MT may transmit a PHR to PN-DU, wherein the PHR comprises a PH value that is determined based on a power adjustment determined based on the DL power adjustment message.

In one example, N-MT may transmit a PHR to PN-DU when N-DU adjusting and/or updating N-DU transmit power by an amount larger than a predetermined or configured power adjustment value, or when the power headroom of N-MT (e.g., PH based on a N-MT reference PUSCH transmission) changes by an amount larger than a predetermined or configured power adjustment value due to N-DU's transmit power adjustment, or when the maximum output power (e.g., configured maximum output power or a component of the configured maximum output power such as MPR due to simultaneous transmissions on N-MT and N-DU (e.g., IAB-MPR)) of the N-MT changes by an amount larger than a predetermined or configured power adjustment value due to N-DU's transmit power adjustment. In another example, the PHR may include a value of PH that is determined based on a value of the N-DU transmit power or a value of the power adjustment to the N-DU transmit power.

In one embodiment: 1)CN-MT transmits a DL power control message to N-DU, wherein the DL power control message includes a requested value of power change ΔP₁: 2)N-DU transmits a response message to CN-MT, wherein the response message includes a granted and/or accepted value of power change ΔP₂—this value may or may not be equal to the requested value of power change ΔP₁; and/or 3)N-MT transmits a PHR to PN-DU, wherein a value of PH in the PHR may be computed or updated based on the requested value of power change ΔP₁ and/or the granted/accepted value of power change ΔP₂. Alternatively, in a similar approach, N may compute a new value of downlink power P_{DL} based on ΔP₁ and/or ΔP₂, and then N-MT transmits a PHR based on a new value of P_{DL}.

In another embodiment, if N-DU receives a DL power adjustment message from CN-MT, N may determine whether N-DU applies a power adjustment in response to the message. If affirmative, N-MT may transmit a control message to PN-DU, wherein the control message includes a UL transmission power parameter that is determined based on a power adjustment determined based on the DL power adjustment message.

In certain embodiments, a UL transmission power parameter is a parameter for determining a value of P_{c,max} based on a power change for a downlink transmission by N-DU. In other embodiments, an UL transmission power parameter is a parameter that replaces P_{c,max} for computing a PH value or another power control parameter in a simultaneous operation mode.

In various embodiments: 1)CN-MT transmits a DL power control message to N-DU, wherein the DL power control message includes a requested value of power change ΔP₁: 2) N-DU transmits a response message to CN-MT, wherein the response message includes a granted and/or accepted value of power change ΔP₂—this value may or may not be equal to the requested value of power change ΔP₁; and/or 3)N-MT transmits a control message to PN-DU, wherein the control message includes a UL transmission power parameter computed or updated based on the requested value of power change ΔP₁ and/or the granted and/or accepted value of power change ΔP₂. Alternatively, in a similar approach, N may compute a new value of downlink power P_{DL} based on ΔP₁ and/or ΔP₂, and then N-MT transmits a control message including a value of UL transmission power parameter based on the new value of P_{DL}.

In certain embodiments, a control message may be an L1 control message such as an uplink control information (“UCI”) message transmitted on a PUCCH or a PUSCH.

In some embodiments, if N-MT receives an availability indication (“AI”) message for an N-DU soft resource, N-MT may transmit a PHR for a PUSCH or an SRS overlapping with the N-DU soft resource.

In various embodiments, instead of transmitting a PHR including a value of PH, N-MT may transmit a control message complementing or augmenting the power headroom reporting process. By following such embodiments, excessively frequent transmissions of PHR may be avoided. Complementing signaling may be referred to as a complementary power headroom report (“C-PHR”) herein. A C-PHR message may be an L1 control message such as an UCI message or a MAC message. The C-PHR message may include a value of ΔPH, which may be a difference between a value of PH, for example the value reported in the latest PHR to the parent node, and a PH value computed based on a condition or associated with a condition or resource. In general, a value of ΔPH may be positive, zero, or negative. When a parent node receives a C-PHR including a value of ΔPH, it may apply a value of PH+ΔPH (or a value of PH-ΔPH) for the IAB node that transmits the C-PHR and in association with a condition or resource. ΔPH may be called a PH offset. In certain embodiments, reporting a positive value of ΔPH, a negative value of ΔPH, or a zero value of ΔPH to parent node may be omitted.

It should be noted that a combination of different embodiments described herein may be made. In some embodiments, a triggering event that is deemed less frequent may trigger a PHR transmission, while a triggering event that is deemed more frequent may trigger a C-PHR transmission. For example, a DL power adjustment by N-DU, which may follow a power adjustment message from CN-MT, may trigger a PHR transmission, while an AI message for a resource may trigger a C-PHR transmission.

In various embodiments, a value of PH or ΔPH may be associated with a condition or resource, or may be triggered based on a triggering event associated with a condition or resource.

In certain embodiments, a value of PH or ΔPH may be associated with an N-DU resource or condition, or it may be triggered by an event associated with an N-DU resource or condition. The resource, condition, or triggering event may be referred to as “per-cell.”

In another embodiment, a value of PH or ΔPH may be associated with a CN-MT resource or condition, or it may be triggered by an event associated with a CN-MT resource or condition. The resource, condition, or triggering event may be referred to as “per-link.”

In yet another embodiment, a value of PH or ΔPH may be associated with a N-DU and CN-MT resource or condition, or it may be triggered by an event associated with a N-DU and CN-MT resource or condition. The resource, condition, or triggering event may be referred to as “per-cell-link.”

In some embodiments, a resource may be addressed by an ID such as a configuration ID that is included in an associated resource configuration IE.

In various embodiments, a value of PH or ΔPH may be associated with a multiplexing mode such as a Case A, Case B, Case C, or Case D multiplexing at the IAB node that transmits a PHR or C-PHR.

According to embodiments in this disclosure, a parent node may maintain multiple values of PH and/or ΔPH associated with an IAB node, a DU cell of an IAB node, a child node served by a DU cell of an IAB node, or the like. As a result, a PHR or C-PHR may include multiple values of PH and/or ΔPH.

In certain embodiments, if a PHR transmission or a C-PHR transmission is triggered, the PHR or C-PHR may include multiple values of PH and/or ΔPH, wherein each of the values may or may not have changed compared to the last associated PHR or C-PHR transmission.

In some embodiments, if a PHR transmission or a C-PHR transmission is triggered, the PHR or C-PHR may include one or more values of PH and/or ΔPH associated with a change of a PH value with respect to corresponding values since a last associated PHR or C-PHR transmission.

In another embodiment, if a PHR transmission or a C-PHR transmission is triggered, the PHR or C-PHR may include one or more values of PH and/or ΔPH associated with a change of a PH value above a certain threshold or below a certain threshold with respect to corresponding values in a last associated PHR or C-PHR transmission.

Embodiments herein may be enabled by configurations from a higher layer such as a radio resource control (“RRC”) entity terminated at an IAB-CU. In some embodiments, one or more RRC IEs may configure a behavior at an IAB node based on any embodiment found herein. The IEs may be sent to the IAB node over a higher layer interface such as an F1 interface.

In various embodiments, communication of RRC IEs from an IAB-CU to an IAB node may follow an IAB capability signaling. For example, the IAB-CU may configure the IAB node to perform a method found herein if the IAB node reports to the IAB-CU, for example via an RRC message after establishing an RRC connection, that: 1) the IAB node is capable of performing enhanced power control, enhanced UL power control, enhanced DL power control, enhanced duplexing. Case A multiplexing, and the like: or 2) the IAB node has a single antenna panel, multiple antenna panels, constraints on transmission power or reception power imbalance, and the like.

In certain embodiments, a plurality of signaling may be referred to as configuring an IAB node. Accordingly, in some embodiments, an IAB node may be configured to perform a method found herein. In various embodiments: 1) an IAB node may perform a method without a configuration and, instead, follow a standard specification for all or a part of the proposed signaling and behavior: or 2) the signaling or behavior may be fully or partially determined by lower layer signaling such as an L1/L2 signaling without a configuration from a higher layer.

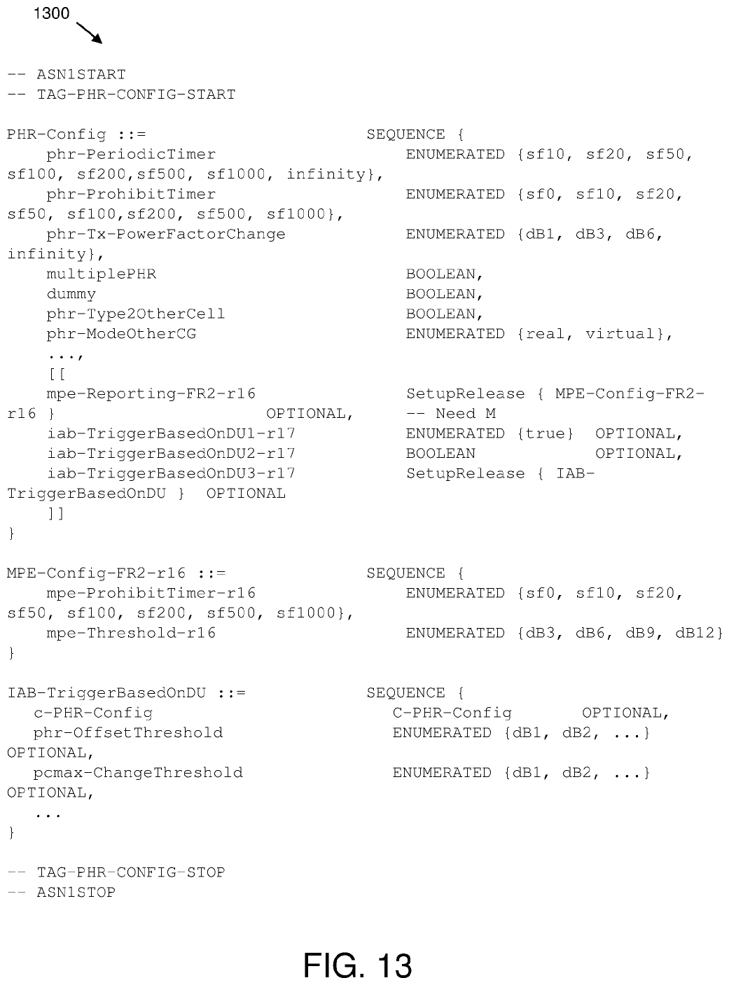

FIG. 13 is a code diagram illustrating one embodiment of an RRC configuration IE 1300.

According to the example abstract syntax notation (“ASN”) 1 (“ASN.1”) code of FIG. 13, an enhanced PHR, C-PHR, or the like may be configured by an IE such as an PHR-Config including additional parameters. The parameter may determine whether to perform an enhanced PHR signaling.

In certain embodiments, a new IE, such as an IAB-TriggerBasedOnDU, which may be sent separately or be included with the PHR-Config IE, may communicate additional information on how to perform enhanced signaling related to PHR, C-PHR, or the like. This configuration IE may indicate additional details on the format of the control message of a C-PHR, a threshold for PHR offset due to a downstream event or parameter, a threshold on P_{c,max} change, and the like.

If a threshold for a PHR offset is indicated, the IAB node may be required to transmit an associated PHR or C-PHR only if the offset is not smaller than the threshold. If a threshold for a P_{c,max} value (or a value for another power control parameter as explained later) is indicated, the IAB node may be required to report a change of the P_{c,max} value (or the value for another power control parameter) only if the change is not smaller than the threshold. Other thresholds may be configured to determine a behavior at the IAB node.

In some embodiments, a PHR offset may be reported (e.g., in a C-PHR) to a parent node or an IAB-CU only if the PHR offset is below a threshold. Then, if the PHR offset is above the threshold, the IAB node transmits a PHR. The threshold may be indicated by a configuration.

In various embodiments, a PHR offset may be reported (e.g., in a C-PHR) to a parent node or an IAB-CU only if the PHR offset is associated with a number of resources or a duration below than a threshold. Then, if the PHR offset is associated with a number of resources or a duration above the threshold, the IAB node transmits a PHR. The threshold may be indicated by a configuration.

In certain embodiments, a change of value for a power control parameter such as P_{c,max} may be reported to the IAB node or an IAB-CU only if the change of value is below a threshold. Then, if the change of value is above the threshold, the IAB node transmits a PHR. The threshold may be indicated by a configuration.

In some embodiments, a parameter related to a downstream event or parameter may trigger a PHR transmission, a C-PHR transmission, a calculation of a new value for a power control parameter, and the like. In any of the embodiments herein, an additional condition may be for an associated resource in the upstream and an associated resource in the downstream to be time-overlapping (“TOL”) (e.g., to overlap in the time domain due to a configuration, an occurrence, an OFDM numerology mismatch between upstream and downstream, a timing misalignment between upstream and downstream, or the like).

For example, a value of PH and an associated PHR may be associated with an UL signal or channel such as a PUSCH or an SRS. The UL signal or channel may occur on a first (e.g., upstream) resource (or resource set) configured for N-MT. On the other side, a resource attribute such as a D/U/F attribute, H/S/NA attribute, availability indication for a soft resource, and the like, may be indicated for a second (e.g., downstream) resource (or resource set) configured for N-DU. Then, a condition to perform a method found herein may for the first resource (or resource set) and the second resource (or resource set) to overlap in time. In certain specifications, however, TOL resources may be referred to as the same resource or, alternatively, be referenced implicitly.

In certain embodiments, a condition for performing a method herein may be based on collocation of N-MT and N-DU. This collocation may be signaled to another entity, such as a parent node or an IAB-CU, or it may be realized by implementation. If the collocation is signaled, the information in the signaling may be used for a power control configuration for a method described herein.

In some embodiments, such as for enhanced power control based on a resource attribute at an IAB node, reference may be made to a resource without an explicit reference to a TOL relationship between resources or a collocation condition for the sake of brevity. It should be noted, however, that a time-overlap between the subject resource and another resource recognized by the IAB node MT and DU and/or a collocation between the MT and DU may be additional conditions for a method to be performed by an IAB node.

In various embodiments, a power headroom value is computed and reported based on a downstream resource.

In one embodiment, an attribute of the downstream resource is a D/U/F attribute (e.g., whether the resource is downlink, uplink, or flexible). If the resource is downlink, the power associated with a transmission (to a child node or a UE) on the resource may be used for computing the power headroom value. If the resource is uplink, the power associated with a reception on the resource (from a child node or a UE) on the resource may be used for computing power imbalance value, which may then be used for computing a power headroom value. If the resource is flexible: 1) the resource may be assumed downlink as a worst case: 2) the resource may be assumed uplink; and/or 3) the resource may not be considered downlink if it does not satisfy a power constraint as signaled by a last PHR report to a parent node.

In another embodiment, the attribute of the downstream resource is an H/S/NA attribute (e.g., whether the resource is a hard resource, a soft resource, or an unavailable resource). If the resource is hard, the power associated with the resource is considered for computing the power headroom value. If the resource is unavailable, a power associated with the resource is not considered for computing the power headroom value. If the resource is soft: 1) a power associated with the resource is not considered for computing the power headroom value: 2) a power associated with the resource is considered for computing the power headroom value: 3) a power associated with the resource is considered for computing the power headroom value if the resource is indicated available; and/or 4) a power associated with the resource is considered for computing the power headroom value if the resource is indicated available prior to a time threshold, wherein the time threshold may be obtained based on a time of the resource and a reception time of an associated availability indication message that indicates whether the resource is available.

In certain embodiments, N-MT receives information of a reference set of N-DU DL transmission parameters to be used for N-MT's virtual PH calculation (e.g., PH based on a N-MT reference PUSCH transmission and N-DU DL reference transmission parameters). Further, N-MT may receive information of the maximum transmit power difference between a N-MT transmit power value and a N-DU transmit power value (e.g., in case of simultaneous transmissions on N-MT and N-DU). For virtual PHR, N-MT determines a virtual power headroom based on the reference set of N-DU DL transmission parameters, a reference set of N-MT UL transmission parameters, and the max transmit power difference. In one example, the configured maximum output power of the N-MT is determined based on the maximum transmit power difference between a N-MT transmit power and a N-DU transmit power.

In some embodiments, a power headroom value is computed and reported based on an upstream resource.

In one embodiment, the attribute of the upstream resource is a D/U/F attribute (e.g., whether the resource is downlink, uplink, or flexible). If the resource is downlink, the power associated with a reception on the resource (from a parent node) on the resource may not be used for computing power imbalance value. If the resource is uplink, the power associated with a transmission (to a parent node) on the resource may be used for computing the power headroom value, which may then be used for computing a power headroom value. If the resource is flexible: 1) the resource may be assumed downlink: 2) the resource may be assumed uplink as a worst case; and/or 3) the resource may not be considered uplink if it does not satisfy a power constraint as signaled by a last PHR report to a parent node.

In another embodiment, the attribute of the upstream resource is an H/S/NA attribute (e.g., whether the resource is a hard resource, a soft resource, or an unavailable resource). If the resource is hard, the power associated with the resource is considered for computing the power headroom value. If the resource is unavailable, a power associated with the resource is not considered for computing the power headroom value. If the resource is soft: 1) a power associated with the resource is not considered for computing the power headroom value: 2) a power associated with the resource is considered for computing the power headroom value: 3) a power associated with the resource is considered for computing the power headroom value if the resource is indicated available; and/or 4) a power associated with the resource is considered for computing the power headroom value if the resource is indicated available prior to a time threshold, wherein the time threshold may be obtained based on a time of the resource and a reception time of an associated availability indication message that indicates whether the resource is available.

In some embodiments, whether to send a PHR may further depend on a spatial/beam constraint and/or timing alignment constraint of a TOL resource of an IAB-MT.

An enhanced PHR or C-PHR, according to embodiments herein may include an indication of a value of dynamic range such as a preferred dynamic range (e.g., maximum transmit power difference between a N-MT transmit power and a N-DU transmit power in case of simultaneous transmissions on N-MT and N-DU). In various embodiments, a value of dynamic range may be reported in a separate message such as a control message associated with a PHR or a C-PHR. Association rules and message formats (for multiple value of dynamic range) may be similar to association rules and message formats proposed for enhanced PHR or C-PHR according to embodiments herein.

In various embodiments, a triggering event or a calculation of PH or a ΔPH may be based on an indication of an MT-DU collocation such as a collocation between an N-DU and an N-MT. Additionally, or alternatively, N-DU and N-MT may share antenna and/or RF hardware to trigger a PHR transmission or C-PHR transmission, calculation of a new value of PH or ΔPH, or a calculation of an associated parameter such as a power control parameter. The MT-DU collocation indication may be in a configuration from the network/CU or in a message from the IAB node comprising the IAB-MT and the IAB-DU, for example, in the form of a capability parameter.

An enhanced PHR or C-PHR, according to embodiments found herein, may additionally, or alternatively, include an indication of a value of an adjacent channel leakage ratio (“ACLR”). Alternatively, the value of ACLR may be reported in a separate message such as a control message associated with a PHR or a C-PHR. Association rules and message formats (for multiple value of dynamic range) may be similar to association rules and message formats proposed for enhanced PHR or C-PHR according to embodiments herein.

In certain embodiments, an enhanced PHR or C-PHR may include an indication of a value of a MPR due to simultaneous transmissions on N-MT and N-DU (e.g., IAB-MPR or IAB-P-MPR). Alternatively, the value of MPR may be reported in a separate message such as a control message associated with a PHR or a C-PHR. Association rules and message formats (e.g., for multiple value of dynamic range) may be similar to association rules and message formats proposed for enhanced PHR or C-PHR according to embodiments described herein.

In some embodiments, for the parent node PN-DU to apply different power control parameters, such as different values of PH, ΔPH, dynamic range, MPR, and ACLR, the parent node may be informed, by an IAB-CU, of associated information for the dynamic switching such as resource configurations. In some realizations, a configuration associated with N-DU and/or CN-MT may be shared with PN over an F1 interface. Then, the parent node PN may apply the different power control parameters dynamically based on the information of configurations associated with N-DU and/or CN-MT.

In various embodiments, an IAB-CU may indicate power constraints associated with N-DU, CN-MT, a transmission from N-DU to CN-MT, a resource for a transmission from N-DU to CN-MT, and/or the like, to a parent node.

In certain embodiments, N-MT transmits a legacy PHR associated with a time-division multiplexing (“TDM”) mode. However, switching to a simultaneous operation mode such as Case A multiplexing may trigger a PHR transmission.

In some embodiments, N-MT transmits a legacy PHR associated with a TDM mode. However, switching to a simultaneous operation mode such as Case A multiplexing may trigger a C-PHR transmission, wherein the C-PHR may include a value of ΔPH (e.g., PH offset).

In various embodiments, N-MT transmits a legacy PHR associated with a TDM mode as well as an enhanced PHR and/or a C-PHR associated with a simultaneous operation mode such as Case A multiplexing. Then, the parent node PN-DU receiving the PHR and/or C-PHR may apply the information of the values of PH and/or PH offset when an associated multiplexing mode is applied at the IAB node N. Application of a multiplexing mode may further depend on D/U/F attributes and/or H/S/NA attributes associated with resources configured for N-DU (e.g., per-cell) and/or CN-MT (e.g., link-based) information of which may be obtained by the parent node from the IAB-CU.

In certain embodiments, if a downstream resource of IAB node N (e.g., a resource used for communication between N-DU and CN-MT) is a soft resource, application of power control parameter such as a PH of a PH offset may further depend on availability of the soft resource, which may be indicated by an AI message from the same parent node or a different parent node.

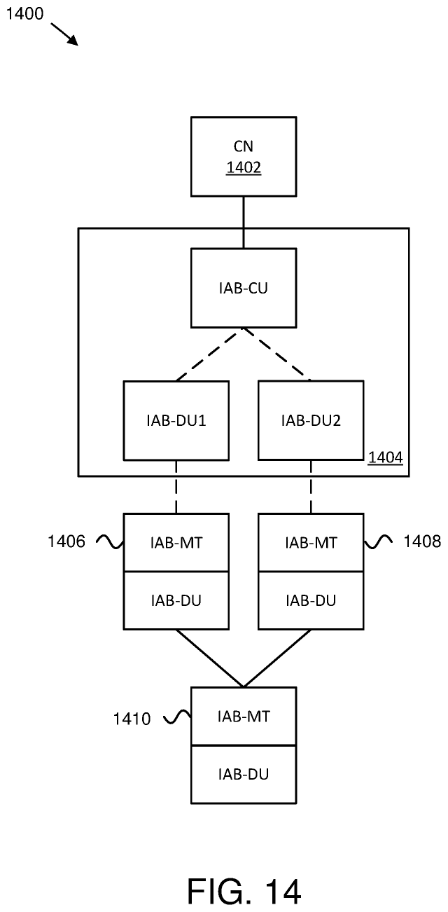

FIG. 14 illustrates an example IAB system with DC at an IAB node where the parent nodes of the IAB node are configured by one IAB donor. This architecture may be referred to as the intra-donor scenario.

Specifically, FIG. 14 is a schematic block diagram illustrating one embodiment of a DC architecture 1400 with one IAB-CU and/or IAB donor (intra-donor scenario). The DC architecture 1400 includes a CN 1402, an IAB donor 1404, a first parent node 1406, a second parent node 1408, and an IAB node 1410.

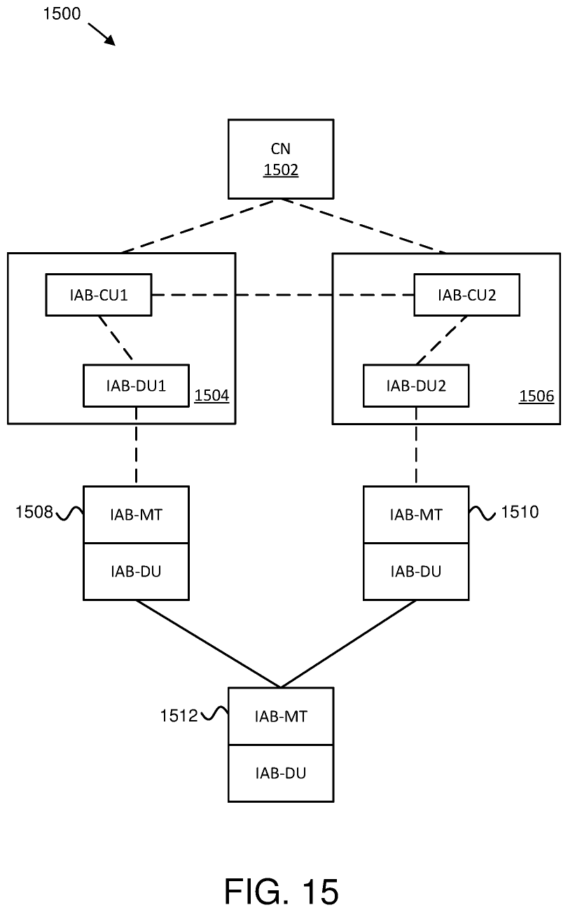

FIG. 15 show dual connectivity at an IAB node wherein each parent node may be configured by a different IAB donor. This architecture may be referred to as the inter-donor scenario.

Specifically, FIG. 15 is a schematic block diagram illustrating one embodiment of a DC architecture 1500 with multiple IAB-CUs and/or IAB donors (intra-donor scenario). The DC architecture 1500 includes a CN 1502, a first IAB donor 1504, a second IAB donor 1506, a first parent node 1508, a second parent node 1510, and an IAB node 1512.

In certain embodiments: 1) there may be a physical layer (“L1”) connection over a Uu link that connects an IAB-MT of the IAB node to serving IAB-DUs of parent nodes: 2) a medium access control (“MAC”) sublayer of the link layer (“L2”): 3) RRC at layer 3:4) higher layer interfaces; and 5) so forth.

It should be noted that IAB nodes in an IAB system may be configured by an IAB-CU of an IAB donor, which may be connected to the IAB nodes over multiple hops (e.g., wireless links) over an F1 interface.

As used herein, physical layer and link layer signaling (e.g., including MAC signaling) may be referred to as “lower-layer” signaling, dynamic signaling, L1/L2 signaling, and the like. For example, a lower-layer signaling may refer to a DCI message on a PDCCH, a UCI message on a PUCCH or a PUSCH, a MAC message, or a combination thereof, unless the term “lower-layer” is specified for an embodiment or realization to refer to a specific signaling such as a DCI message or a MAC message.

Moreover, as used herein, signaling by RRC and/or signaling over interfaces such as F1 and Xn may be referred to as “higher-layer” signaling, a higher-layer configuration, or a configuration. For example, a higher-signaling or configuration may refer to an RRC IE, an FIAP IE, an XnAP IE, and the like.

In some embodiments, a DCI message indicating an attribute for a downstream resource of the IAB-MT may trigger a PHR transmission or a C-PHR transmission, wherein the DCI message may be transmitted by a first parent node and the PHR is sent to a second parent node. Alternatively, upon receiving the DCI message, the IAB node may calculate a new value for a power control parameter, and then if the power control parameter changes by any value, or alternatively by a value above a threshold, then the IAB node may transmit a PHR or a C-PHR comprising information of the newly calculated power control parameter.

In various embodiments, a DCI message may be an AI message including values of AI for a downstream resource in the time domain and/or the frequency domain. A downstream resource may refer to a resource configured for an operation (e.g., a transmission and/or a reception) by N-DU, CN-MT, or both.

For example, consider an IAB node N served by two parent nodes PN1 and PN2. In one realization, the master node PN1 may transmit an AI message to N, wherein the AI message comprises an availability value for a downstream resource. This may trigger a PHR transmission or C-PHR transmission to the secondary node PN2 associated with the resource or an operation on the resource.

In another realization, the secondary node PN2 may transmit an AI message to N, wherein the AI message includes an availability value for a downstream resource. This may trigger a PHR transmission or C-PHR transmission to the master node PN1 associated with the resource or an operation on the resource.

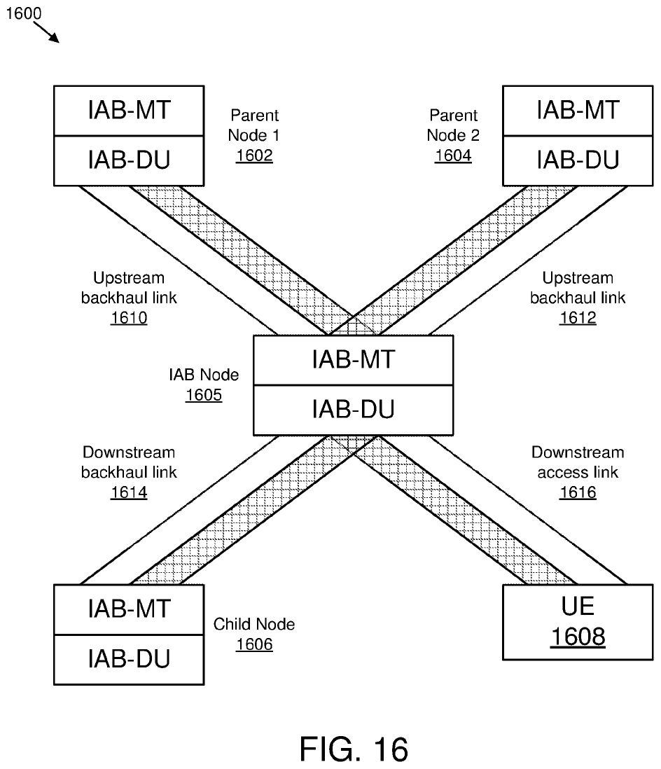

FIG. 16 is a schematic block diagram illustrating one embodiment of a system 1600 showing alternative scenarios for simultaneous operations. The system 1600 includes a parent node 1 1602, a parent node 2 1604, an IAB node 1605, a child node 1606, and a UE 1608 that use upstream backhaul links 1610 and 1612, and downstream backhaul links 1614 and 1616. In FIG. 16, each of the backhaul and access links in upstream and downstream of the IAB node may have resources (e.g., not filled) that are not overlapping with resources used in other links. However, some resources (e.g., shaded) on one link may be overlapping with resources on one or multiple other links in time, frequency, and/or spatial domains. Particularly, if resources are overlapping in the time domain, methods for simultaneous operations may be applied.

In various embodiments, reference is made to references as methods similar to those proposed in the references are applicable for multiplexing among upstream links (e.g., DC scenarios).

In various embodiments, reference is made to time-overlapping (“TOL”) resources such as TOL symbols, although the standard specification may use a different term for overlapping resources or simply refer to “same” resources. Moreover, TOL resources may be defined or configured for different entities, such as different IAB nodes, an IAB-MT and IAB-DU of an IAB node, and so forth. In certain embodiments, there may be cases with different numerologies where a symbol in a first operation and/or configuration may not have the same length in time as a symbol in a second operation and/or configuration. In some embodiments, there may be cases having a timing misalignment, whether deliberate due to employing different timing alignments or due to an error.

In certain embodiments, TOL, as a relationship between two resources, is commutative (e.g., if a first resource and/or symbol A is time-overlapping with a second resource and/or symbol B, then B is also TOL with A). In some embodiments, there may be a symbol in a first operation and/or configuration and a TOL symbol in a second operation and/or configuration.

In some embodiments, a type of resource may be used to allow an IAB node to perform simultaneous operation either based on a best-effort method or otherwise. This type of resource may be called DL+UL, which may or may not be interpreted as a flexible (F) symbol.

In various embodiments, a DL+UL symbol may be realized by using a new value in addition to DL, UL, and F. This may require altering the structure of certain messages.

In some embodiments, a DL+UL symbol may be realized by separate signaling. An example of the separate signaling is the TDD-UL-DL-ConfigDedicated2-r17 IE as described in several embodiments herein. If such new IE is used, it may be treated similarly as ‘TDD-Config” in the table of’ scenarios for DL-UL conflict resolution. A similar principle may be used to introduce control messages with structures similar to that of SFI, for example.

In certain embodiments, configurations and signaling described herein may include parameters indicating a beam applied for a transmission or a reception, a transmission power to apply for a transmission, a timing alignment method applied for a transmission or a reception, and so forth. Moreover, a beam may refer to a spatial filter for a transmission or a reception by a node on an antenna panel or antenna port.

In some embodiments, a beam may be referred to by a term such as a spatial filter or spatial parameters. A transmission and/or reception of a signal with a beam may refer to application of a spatial filter (or spatial parameters) similar to that of another transmission and/or reception of another signal. “Determining” a beam may follow a beamforming training process including transmission and/or reception of reference signals by applying different beams and performing measurements on the signals. “Indicating” a beam may refer to transmitting a message to another node, the message including information of a beam/spatial filter in the form of a transmission configuration indication (“TCI”) including a spatial quasi collocation (“QCL”) or QCL Type D, a spatial relation parameter, or the like.

In various embodiments, a transmission power may be determined or indicated by signaling. The signaling may be semi-static such as by an RRC configuration and/or a control message such as a MAC CE message or a DCI/L1 message. Transmission power control may be applied to uplink transmissions, downlink transmissions, or both, which may be determined by the standard, a configuration, and/or a control signaling.

In certain embodiments, a timing alignment method may be determined or indicated by signaling. The signaling may be semi-static such as by an RRC configuration and/or a control message such as a MAC CE message or a DCI/L1 message. In some embodiments, a timing alignment method may be determined by a duplexing/multiplexing case. For example, Case A (e.g., simultaneous transmission) at a node may automatically trigger a timing alignment mode based on “Case-6” timing alignment, where transmissions are aligned, whereas Case B (e.g., simultaneous reception) at a node may automatically trigger a timing alignment mode based on “Case-7” timing alignment, where receptions are aligned. Whether and how a timing alignment method is triggered or applied may be determined by the standard, a configuration, and/or a control signaling.

In certain embodiments, configurations may be RRC configurations that an IAB node (or a UE) may receive from an IAB-CU. The configurations may include parameters for reference signals such as resources allocated for the reference signals, signaling to trigger transmission of a reference signal, beam/spatial relations and transmission power, and so forth.

In some embodiments, a reference signal for an interference evaluation may be any reference signal based on which an interference may be measured. For example, a channel state information reference signal (“CSI-RS”) may be used for downlink (e.g., when interference by an IAB-DU is to be measured), while a sounding reference signal (“SRS”) may be used for uplink (e.g., when interference by an IAB-MT or a UE is to be measured). Other types of reference signals are not precluded. Once a reference signal is transmitted, it can be received by other nodes (e.g., IAB nodes or UEs) to measure a reference signal receive power (“RSRP”), a reference signal reception quality (“RSRQ”), or the like. An alternative to a reference signal may be any other transmission based on which an interference or a received signal power such as a received signal strength indicator (“RSSI”) may be computed.

Various types of reference signals may be specified for new radio (“NR”), which may be used as a starting point for realizing embodiments herein. In NR, a reference signal may be periodic, semi-persistent, or aperiodic. A periodic reference signal is transmitted as long as the RRC configuration of the reference signal is valid. A semi-persistent reference signal is configured by an RRC IE, but its transmission is controlled by MAC CE signaling. An aperiodic reference signal is configured by an RRC IE, but its transmission is triggered by physical layer and/or layer 1 (“L1”) signaling (e.g., a DCI message). In all those cases, the RRC configuration includes parameters indicating which resources are allocated to a reference signal, while the additional MAC CE or DCI signaling may further activate/deactivate or trigger a transmission of the reference signal.

In various embodiments, a parent node or another local node may signal to execute one of the methods found herein based on information such as an IAB node capability, a number of panels, a type of simultaneous operation (e.g., which may itself be determined by resource configurations and resource multiplexing), an IAB node mobility, a history of success or failure associated with a type of duplexing/multiplexing, or the like.

In certain embodiments, the terms antenna, panel, and antenna panel are used interchangeably. An antenna panel may be a hardware that is used for transmitting and/or receiving radio signals at frequencies lower than 6 GHz (e.g., frequency range 1 (“FR1”)), higher than 6 GHz (e.g., frequency range 2 (“FR2”)), or millimeter wave (“mmWave”). In some embodiments, an antenna panel may include an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device (e.g., UE, node) to amplify signals that are transmitted or received from one or multiple spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a radio frequency (“RF”) chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a UE's own implementation, a “UE panel” may have at least one of the following functionalities as an operational role of unit of antenna group to control its transmit (“TX”) beam independently, unit of antenna group to control its transmission power independently, and/pr unit of antenna group to control its transmission timing independently. The “UE panel” may be transparent to a gNB. For certain conditions, a gNB or network may assume that a mapping between a UE's physical antennas to the logical entity “UE panel” may not be changed. For example, a condition may include until the next update or report from UE or include a duration of time over which the gNB assumes there will be no change to mapping. A UE may report its UE capability with respect to the “UE panel” to the gNB or network. The UE capability may include at least the number of “UE panels.” In one embodiment, a UE may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qel-Type may take one of the following values: 1) ‘QCL-TypeA’: {Doppler shift, Doppler spread, average delay, delay spread}: 2) ‘QCL-TypeB’: {Doppler shift, Doppler spread}: 3) ‘QCL-TypeC’: {Doppler shift, average delay}; and 4) ‘QCL-TypeD’: {Spatial Rx parameter}. Other QCL-Types may be defined based on combination of one or large-scale properties.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mm Wave, frequency range 2 (“FR2”), and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”) ports of the target transmission during a transmission occasion) and a source reference signal (e.g., synchronization signal block (“SSB”), CSI-RS, and/or sounding reference signal (“SRS”)) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

In various embodiments described herein, although entities are referred to as IAB nodes, the same embodiments can be applied to IAB donors (e.g., which are the IAB entities connecting the core network to the IAB network) with minimum or zero modifications. Moreover, different steps described for different embodiments may be permuted. Further, each configuration may be provided by one or more configurations in practice. An earlier configuration may provide a subset of parameters while a later configuration may provide another subset of parameters. In certain embodiments, a later configuration may override values provided by an earlier configuration or a pre-configuration.

In some embodiments, a configuration may be provided by radio resource control (“RRC”) signaling, medium-access control (“MAC”) signaling, physical layer signaling such as a downlink control information (“DCI”) message, a combination thereof, or other methods. A configuration may include a pre-configuration or a semi-static configuration provided by a standard, by a vendor, and/or by a network and/or operator. Each parameter value received through configuration or indication may override previous values for a similar parameter.

In various embodiments, despite frequent references to IAB, embodiments herein may be applicable to wireless relay nodes and other types of wireless communication entities. Further, layer 1 (“L1”) and/or layer 2 (“L2”) control signaling may refer to control signaling in layer 1 (e.g., physical layer) or layer 2 (e.g., data link layer). Particularly, an L1 and/or L2 control signaling may refer to an L1 control signaling such as a DCI message or an uplink control information (“UCI”) message, an L2 control signaling such as a MAC message, or a combination thereof. A format and an interpretation of an L1 and/or L2 control signaling may be determined by a standard, a configuration, other control signaling, or a combination thereof.

It should be noted that any parameter discussed in this disclosure may appear, in practice, as a linear function of that parameter in signaling or specifications.

In various embodiments, vendor manufacturing IAB systems and/or devices and an operator deploying the IAB systems and/or devices may be allowed to negotiate capabilities of the systems and/or devices. This may mean that some of the information assumed to need signaling between entities may readily be available to the devices, for example, by storing the information on a memory unit such as a read-only memory (“ROM”), exchanging the information by proprietary signaling methods, providing the information by a (pre) configuration, or otherwise taking the information into account when creating hardware and/or software of the IAB systems and/or devices or other entities in the network. In certain embodiments, embodiments described herein that include exchanging information may be extended to similar embodiments wherein the information is obtained by other embodiments.

Further, embodiments used for an IAB mobile terminal (“MT”) (“IAB-MT”) may be adopted by a UE as well. If an embodiment uses a capability that is not supported by a legacy UE, a UE enhanced to possess the capability may be used. In this case, the UE may be referred to as an enhanced UE or an IAB-enhanced UE and may convey its information of its enhanced capability to the network for proper configuration and operation.

As used herein, a node or a wireless node may refer to an IAB node, an IAB-DU, an IAB-MT, a UE, a base station (“BS”), a gNodeB (“gNB”), a transmit-receive point (“TRP”), an IAB donor, and so forth. The embodiments herein with an emphasis on a type of nodes are not meant to limit scope.

In certain embodiments, may be used to perform measurements for beam training on reference signals. In some embodiments, a measurement may be performed on resources that are not necessarily configured for reference signals, but rather a node may measure a receive signal power and obtain a RSSI or the like.

In various embodiments, phrases such as Case C or Case D multiplexing are just a matter of nomenclature. Instead, a Case C multiplexing may be identified by an uplink transmission by a node's IAB-MT and an uplink reception by a node's IAB-DU. Similarly, a Case D multiplexing may be identified by a downlink reception by a node's IAB-MT and a downlink transmission by a node's IAB-DU. In general, depending on node capabilities such as multi-panel and/or full-duplex capabilities of an IAB node, one or more of the defined multiplexing cases may be operational at a given moment. For example, if an IAB node transmits an uplink signal to parent node while transmitting to and receiving signals from child nodes, the IAB node may be performing Case A and Case C multiplexing simultaneously. It should be, hence, noted that the methods described herein are not bound to specific multiplexing cases. Different steps/elements explained in the proposed methods may be mixed and matched to realize different multiplexing cases without an explicit mention of how the information obtained by measurements and signaling may be used.

In certain embodiments, reference is made to beam indication. In practice, a beam indication may refer to an indication of a reference signal by an ID or indicator, a resource associated with a reference signal, a spatial relation information comprising information of a reference signal, or a reciprocal of a reference signal (e.g., for beam correspondence).

As used herein, hybrid automatic repeat request (“HARQ”) ACK “HARQ-ACK” may represent collectively the positive acknowledge (“ACK”) and the negative acknowledge (“NACK” or “NAK”). ACK means that a transport block (“TB”) is correctly received while NACK (or NAK) means a TB is erroneously received.

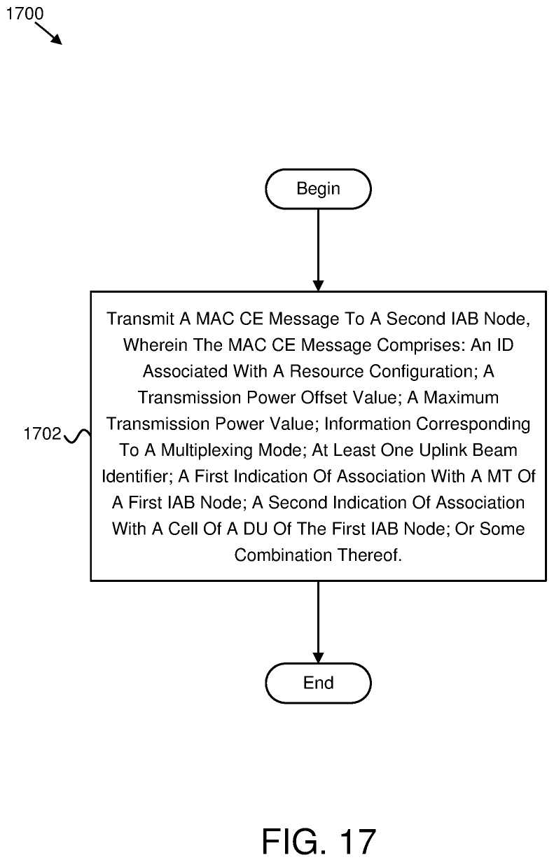

FIG. 17 is a flow chart diagram illustrating one embodiment of a method 1700 for transmitting a MAC CE message by an IAB node. In some embodiments, the method 1700 is performed by an apparatus, such as the remote unit 102 and/or the network unit 104. In certain embodiments, the method 1700 may be performed by a processor executing program code, for example, a microcontroller, a microprocessor, a CPU, a GPU, an auxiliary processing unit, a FPGA, or the like.

In various embodiments, the method 1700 includes transmitting 1702, at a first IAB node, a MAC CE message to a second IAB node. The MAC CE message includes: an ID associated with a resource configuration: a transmission power offset value: a maximum transmission power value: information corresponding to a multiplexing mode: at least one uplink beam identifier: a first indication of association with a MT of the first IAB node: a second indication of association with a cell of a DU of the first IAB node: or some combination thereof.

In certain embodiments, the second IAB node is a parent node of the first IAB node, and the MAC CE message indicates a range of transmission power for an uplink from the first IAB node to the second IAB node. In some embodiments, the range is indicated by a combination of the maximum transmission power value and the transmission power offset value. In various embodiments, the resource configuration is provided by a RRC entity.

In one embodiment, the MAC CE message indicates that the parent node applies the range in response to the first IAB node using a resource associated with the resource configuration. In certain embodiments, the MAC CE message indicates that the parent node applies the range in response to the first IAB node using an associated frequency resource. In some embodiments, the multiplexing mode comprises: the MT transmitting and the DU transmitting: the MT receiving and the DU receiving: the MT transmitting and the DU receiving: the MT receiving and the MT transmitting: or some combination thereof.

In various embodiments, the MAC CE message indicates that the parent node applies the range in response to the first IAB node applying the indicated multiplexing mode. In one embodiment, the MAC CE message indicates that the parent node applies the range in response to the first IAB node applying a beam indicated by the at least one uplink beam identifier. In certain embodiments, the MAC CE message is associated with third IAB node, and the third IAB node is a child node of the first IAB node.

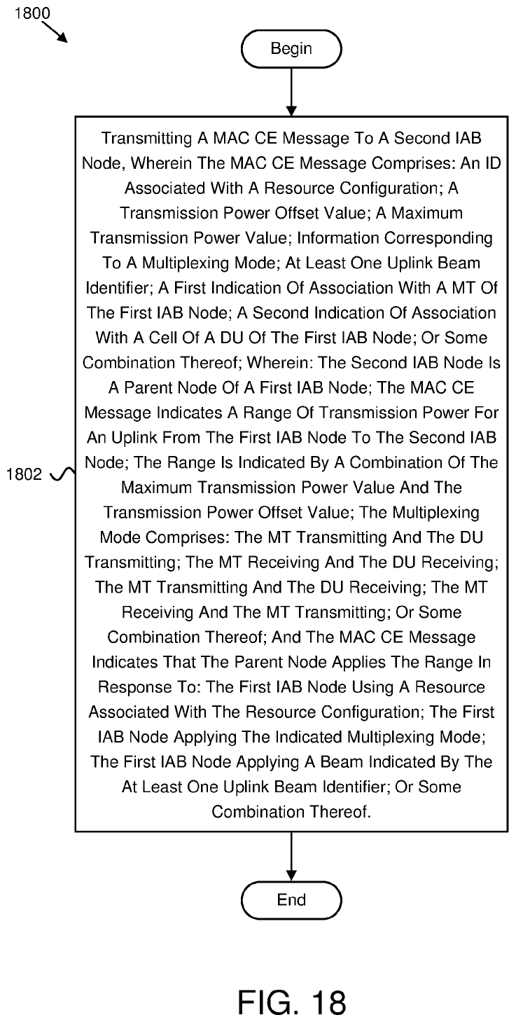

FIG. 18 is a flow chart diagram illustrating another embodiment of a method 1800 for transmitting a MAC CE message by an IAB node. In some embodiments, the method 1800 is performed by an apparatus, such as the remote unit 102 and/or the network unit 104. In certain embodiments, the method 1800 may be performed by a processor executing program code, for example, a microcontroller, a microprocessor, a CPU, a GPU, an auxiliary processing unit, a FPGA, or the like.

In various embodiments, the method 1800 includes transmitting 1802, at a first IAB node, a MAC CE message to a second IAB node. The MAC CE message includes: an ID associated with a resource configuration: a transmission power offset value: a maximum transmission power value: information corresponding to a multiplexing mode: at least one uplink beam identifier; a first indication of association with a MT of the first IAB node: a second indication of association with a cell of a DU of the first IAB node: or some combination thereof. The second IAB node is a parent node of the first IAB node. The MAC CE message indicates a range of transmission power for an uplink from the first IAB node to the second IAB node. The range is indicated by a combination of the maximum transmission power value and the transmission power offset value. The multiplexing mode includes: the MT transmitting and the DU transmitting: the MT receiving and the DU receiving: the MT transmitting and the DU receiving: the MT receiving and the MT transmitting: or some combination thereof. The MAC CE message indicates that the parent node applies the range in response to: the first IAB node using a resource associated with the resource configuration: the first IAB node applying the indicated multiplexing mode: the first IAB node applying a beam indicated by the at least one uplink beam identifier: or some combination thereof.

In one embodiment, an apparatus comprising a first IAB node, the apparatus further comprising: a transmitter to transmit a MAC CE message to a second IAB node, wherein the MAC CE message comprises: an ID associated with a resource configuration: a transmission power offset value: a maximum transmission power value: information corresponding to a multiplexing mode: at least one uplink beam identifier: a first indication of association with a MT of the first IAB node: a second indication of association with a cell of DU of the first IAB node: or some combination thereof.

In certain embodiments, the second IAB node is a parent node of the first IAB node, and the MAC CE message indicates a range of transmission power for an uplink from the first IAB node to the second IAB node.

In some embodiments, the range is indicated by a combination of the maximum transmission power value and the transmission power offset value.

In various embodiments, the resource configuration is provided by a RRC entity.

In one embodiment, the MAC CE message indicates that the parent node applies the range in response to the first IAB node using a resource associated with the resource configuration.

In certain embodiments, the MAC CE message indicates that the parent node applies the range in response to the first IAB node using an associated frequency resource.

In some embodiments, the multiplexing mode comprises: the MT transmitting and the DU transmitting: the MT receiving and the DU receiving: the MT transmitting and the DU receiving: the MT receiving and the MT transmitting: or some combination thereof.

In various embodiments, the MAC CE message indicates that the parent node applies the range in response to the first IAB node applying the indicated multiplexing mode.

In one embodiment, the MAC CE message indicates that the parent node applies the range in response to the first IAB node applying a beam indicated by the at least one uplink beam identifier.

In certain embodiments, the MAC CE message is associated with third IAB node, and the third IAB node is a child node of the first IAB node.

In one embodiment, a method at a first IAB node, the method comprises: transmitting a MAC CE message to a second IAB node, wherein the MAC CE message comprises: an ID associated with a resource configuration: a transmission power offset value: a maximum transmission power value: information corresponding to a multiplexing mode: at least one uplink beam identifier: a first indication of association with a MT of the first IAB node: a second indication of association with a cell of a DU of the first IAB node: or some combination thereof.

In certain embodiments, the second IAB node is a parent node of the first IAB node, and the MAC CE message indicates a range of transmission power for an uplink from the first IAB node to the second IAB node.

In some embodiments, the range is indicated by a combination of the maximum transmission power value and the transmission power offset value.

In various embodiments, the resource configuration is provided by a RRC entity.

In one embodiment, the MAC CE message indicates that the parent node applies the range in response to the first IAB node using a resource associated with the resource configuration.

In certain embodiments, the MAC CE message indicates that the parent node applies the range in response to the first IAB node using an associated frequency resource.

In some embodiments, the multiplexing mode comprises: the MT transmitting and the DU transmitting: the MT receiving and the DU receiving: the MT transmitting and the DU receiving: the MT receiving and the MT transmitting: or some combination thereof.

In various embodiments, the MAC CE message indicates that the parent node applies the range in response to the first IAB node applying the indicated multiplexing mode.

In one embodiment, the MAC CE message indicates that the parent node applies the range in response to the first IAB node applying a beam indicated by the at least one uplink beam identifier.

In certain embodiments, the MAC CE message is associated with third IAB node, and the third IAB node is a child node of the first IAB node.

In one embodiment, an apparatus comprising a first IAB node, the apparatus further comprising: a transmitter to transmit a MAC CE message to a second IAB node, wherein the MAC CE message comprises: an ID associated with a resource configuration: a transmission power offset value: a maximum transmission power value: information corresponding to a multiplexing mode: at least one uplink beam identifier: a first indication of association with a MT of the first IAB node: a second indication of association with a cell of a DU of the first IAB node: or some combination thereof: wherein: the second IAB node is a parent node of the first IAB node: the MAC CE message indicates a range of transmission power for an uplink from the first IAB node to the second IAB node: the range is indicated by a combination of the maximum transmission power value and the transmission power offset value: the multiplexing mode comprises: the MT transmitting and the DU transmitting: the MT receiving and the DU receiving: the MT transmitting and the DU receiving: the MT receiving and the MT transmitting: or some combination thereof; and the MAC CE message indicates that the parent node applies the range in response to: the first IAB node using a resource associated with the resource configuration: the first IAB node applying the indicated multiplexing mode: the first IAB node applying a beam indicated by the at least one uplink beam identifier: or some combination thereof.

In one embodiment, a method at a first IAB node, the method comprising: transmitting a MAC CE message to a second IAB node, wherein the MAC CE message comprises: an ID associated with a resource configuration: a transmission power offset value: a maximum transmission power value: information corresponding to a multiplexing mode: at least one uplink beam identifier: a first indication of association with a MT of the first IAB node: a second indication of association with a cell of a DU of the first IAB node: or some combination thereof: wherein: the second IAB node is a parent node of the first IAB node: the MAC CE message indicates a range of transmission power for an uplink from the first IAB node to the second IAB node; the range is indicated by a combination of the maximum transmission power value and the transmission power offset value; the multiplexing mode comprises: the MT transmitting and the DU transmitting; the MT receiving and the DU receiving; the MT transmitting and the DU receiving; the MT receiving and the MT transmitting; or some combination thereof; and the MAC CE message indicates that the parent node applies the range in response to: the first IAB node using a resource associated with the resource configuration; the first IAB node applying the indicated multiplexing mode; the first IAB node applying a beam indicated by the at least one uplink beam identifier; or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A first integrated access and backhaul (IAB) node, comprising:
at least one memory; and
at least one processor coupled with the at least one memory and configured to cause the first IAB node to:
transmit a medium access control (MAC) control element (CE) message to a second IAB node, wherein the MAC CE message comprises:
an identifier (ID) associated with a resource configuration;
a transmission power offset value;
a maximum transmission power value;
information corresponding to a multiplexing mode;
at least one uplink beam identifier;
a first indication of association with a mobile terminal (MT) of the first IAB node;
a second indication of association with a cell of a distributed unit (DU) of the first IAB node;
or a combination thereof.

2. The first IAB node of claim 1, wherein the second IAB node is a parent node of the first IAB node, and the MAC CE message indicates a range of transmission power for an uplink from the first IAB node to the second IAB node.

3. The first IAB node of claim 2, wherein the range is indicated by a combination of the maximum transmission power value and the transmission power offset value.

4. The first IAB node of claim 1, wherein the resource configuration is provided by a radio resource control (RRC) entity.

5. The first IAB node of claim 2, wherein the MAC CE message indicates that the parent node applies the range in response to the first IAB node using a resource associated with the resource configuration.

6. The first IAB node of claim 2, wherein the MAC CE message indicates that the parent node applies the range in response to the first IAB node using an associated frequency resource.

7. The first IAB node of claim 1, wherein the multiplexing mode comprises:
the MT transmitting and the DU transmitting;
the MT receiving and the DU receiving;
the MT transmitting and the DU receiving;
the MT receiving and the MT transmitting;
or a combination thereof.

8. The first IAB node of claim 2, wherein the MAC CE message indicates that the parent node applies the range in response to the first IAB node applying the indicated multiplexing mode.

9. The first IAB node of claim 2, wherein the MAC CE message indicates that the parent node applies the range in response to the first IAB node applying a beam indicated by the at least one uplink beam identifier.

10. The first IAB node of claim 1, wherein the MAC CE message is associated with third IAB node, and the third IAB node is a child node of the first IAB node.

11. A method of a first integrated access and backhaul (IAB) node, the method comprising:
transmitting a medium access control (MAC) control element (CE) message to a second IAB node, wherein the MAC CE message comprises:
an identifier (ID) associated with a resource configuration;
a transmission power offset value;
a maximum transmission power value;
information corresponding to a multiplexing mode;
at least one uplink beam identifier;
a first indication of association with a mobile terminal (MT) of the first IAB node;
a second indication of association with a cell of a distributed unit (DU) of the first IAB node;
or a combination thereof.

12. The method of claim 11, wherein the second IAB node is a parent node of the first IAB node, and the MAC CE message indicates a range of transmission power for an uplink from the first IAB node to the second IAB node.

13. The method of claim 12, wherein the range is indicated by a combination of the maximum transmission power value and the transmission power offset value.

14. The method of claim 11, wherein the resource configuration is provided by a radio resource control (RRC) entity.

15. A first integrated access and backhaul (IAB) node, comprising:
at least one memory; and
at least one processor coupled with the at least one memory and configured to cause the first IAB node to:
to transmit a medium access control (MAC) control element (CE) message to a second IAB node, wherein the MAC CE message comprises:
an identifier (ID) associated with a resource configuration;
a transmission power offset value;
a maximum transmission power value;
information corresponding to a multiplexing mode;
at least one uplink beam identifier;
a first indication of association with a mobile terminal (MT) of the first IAB node;
a second indication of association with a cell of a distributed unit (DU) of the first IAB node;
or a combination thereof;
wherein:
the second IAB node is a parent node of the first IAB node;
the MAC CE message indicates a range of transmission power for an uplink from the first IAB node to the second IAB node;
the range is indicated by a combination of the maximum transmission power value and the transmission power offset value;
the multiplexing mode comprises:
the MT transmitting and the DU transmitting;
the MT receiving and the DU receiving;
the MT transmitting and the DU receiving;
the MT receiving and the MT transmitting;
or a combination thereof; and
the MAC CE message indicates that the parent node applies the range in response to:
the first IAB node using a resource associated with the resource configuration;
the first IAB node applying the indicated multiplexing mode;
the first IAB node applying a beam indicated by the at least one uplink beam identifier;
or a combination thereof.

16. A method of a first integrated access and backhaul (IAB) node, the method comprising:
transmitting a medium access control (MAC) control element (CE) message to a second IAB node, wherein the MAC CE message comprises:
an identifier (ID) associated with a resource configuration;
a transmission power offset value;
a maximum transmission power value;
information corresponding to a multiplexing mode;
at least one uplink beam identifier;
a first indication of association with a mobile terminal (MT) of the first IAB node;
a second indication of association with a cell of a distributed unit (DU) of the first IAB node;
or a combination thereof;
wherein:
the second IAB node is a parent node of the first IAB node;
the MAC CE message indicates a range of transmission power for an uplink from the first IAB node to the second IAB node;
the range is indicated by a combination of the maximum transmission power value and the transmission power offset value;
the multiplexing mode comprises:
the MT transmitting and the DU transmitting;
the MT receiving and the DU receiving;
the MT transmitting and the DU receiving;
the MT receiving and the MT transmitting;
or a combination thereof; and
the MAC CE message indicates that the parent node applies the range in response to:
the first IAB node using a resource associated with the resource configuration;
the first IAB node applying the indicated multiplexing mode;
the first IAB node applying a beam indicated by the at least one uplink beam identifier;
or a combination thereof.

17. The method of claim 16, wherein the MAC CE message indicates that the parent node applies the range in response to the first IAB node using a resource associated with the resource configuration.

18. The method of claim 17, wherein the MAC CE message indicates that the parent node applies the range in response to the first IAB node using an associated frequency resource.

19. The method of claim 16, wherein the multiplexing mode comprises:
the MT transmitting and the DU transmitting;
the MT receiving and the DU receiving;
the MT transmitting and the DU receiving;
the MT receiving and the MT transmitting;
or a combination thereof.

20. The method of claim 16, wherein the MAC CE message indicates that the parent node applies the range in response to the first IAB node applying the indicated multiplexing mode.
